(19) United States
(12) Patent Application Publication
(10) Pub. No.: US 2010/0251189 A1
(43) Pub. Date: Sep. 30, 2010

(54) Using gesture objects to replace menus for computer control

(76) Inventor: Denny Jaeger, Oakland, CA (US)

Correspondence Address: ZIMMERMAN & CRONEN, LLP, 1330 BROADWAY, SUITE 710, OAKLAND, CA, 94612-2506, US

(21) Appl. No.: 12/653,265

(22) Filed: Dec. 9, 2009

Related U.S. Application Data
(60) Provisional application No. 61/201,386, filed on Dec. 9, 2008.

(51) Int. Cl. G06F 3/033

(52) U.S. Cl. 715/863

(57) ABSTRACT

The present invention generally comprises a computer control environment that builds on the Blackspace™ software system to provide further functionality and flexibility in directing a computer. It employs graphic inputs drawn by a user and known as gestures to replace and supplant the pop-up and pull-down menus known in the prior art.

### CROSS-REFERENCE TO RELATED APPLICATIONS

This application claims the priority date benefit of Provisional Application No. 61/201,386, filed Dec. 9, 2008.

### FEDERALLY SPONSORED RESEARCH

Not applicable.

### SEQUENCE LISTING, ETC ON CD

Not applicable.

### BACKGROUND OF THE INVENTION

1. Field of the Invention

The invention relates generally to computer operating environments, and more particularly to a method for performing operations in a computer operating environment.

2. Description of Related Art

A newly introduced computer operating arrangement known as Blackspace™ has been created to enable computer users to direct a computer to perform according to graphic inputs made by a computer user. One aspect of Blackspace is generally described as a method for creating user-defined computer operations that involve drawing an arrow in response to user input and associating at least one graphic to the arrow to designate a transaction for the arrow. The transaction is designated for the arrow after analyzing the graphic object and the arrow to determine if the transaction is valid for the arrow. The following patents describe this system generally: U.S. Pat. No. 6,883,145, issued Apr. 19, 2005, titled Arrow Logic System for Creating and Operating Control Systems; U.S. Pat. No. 7,240,300, issued Jul. 3, 2007, titled Method for Creating User-Defined Computer Operations Using Arrows. These patents are incorporated herein by reference in their entireties. The present invention comprises improvements and applications of these system concepts.

### BRIEF SUMMARY OF THE INVENTION

The present invention generally comprises a computer control environment that builds on the Blackspace™ software system to provide further functionality and flexibility in directing a computer. It employs graphic inputs drawn by a user and known as gestures to replace and supplant the pop-up and pull-down menus known in the prior art.

### BRIEF DESCRIPTION OF THE DRAWING

FIGS. 1-84 describe various aspects of the use of Gestures to replace pull down or popup menus or menu entries in computer control tasks with simple graphic entries drawn by a user in a computer environment.

### DETAILED DESCRIPTION OF THE INVENTION

The present invention generally comprises various embodiments of the Gestures computer control environment that permit a user to have increased efficiency for operating a computer. The description of these embodiments utilizes the Blackspace environment for purposes of example and illustration only. These embodiments are not limited to the Blackspace environment. Indeed these embodiments have application to the operation of virtually any computer and computer environment and any software that is used, to operate, control, direct, cause actions, functions, operations or the like, including for desktops, web pages, software applications, and the like.

Key areas of focus include:

1) Removing the need for text in menus, represented in Blackspace as IVDACCs, which is an acronym for “Information VDACC.” A VDACC is an acronym for “Virtual Display and Control Canvas.
2) Removing the need for menus altogether.

Regarding word processing: A VDACC is an object found in Blackspace. As an object it can be used to manage other objects on one or more canvases. A VDACC also has properties which enable it to display margins for text. In other software applications dedicated word processing windows are used for text. Many of the embodiments found herein can apply to both VDACC type word processing and windows type word processing. Subsequent sections in this provisional application include embodiments that permits users to program computers via graphical means, verbal means, drag and drop means, and gesture means.

There are two considerations regarding menus: (1) Removing the need for language in menus, and (2) removing the need for menu entries entirely. Regarding VDACCs and IVDACCs, see “Intuitive Graphic User Interface with Universal Tools,” Pub. No.: US 2005/0034083, Pub. Date: Feb. 10, 2005, incorporated herein by reference.

This invention includes various embodiments that fall into both categories. The result of the designs described below is to greatly reduce the number of menu entries and menus required to operate a computer and at the same time to increase the speed and efficiency of its operation. The operations, functions, applications, methods, actions and the like described herein apply to all software and to all computer environments. Blackspace is used as an example only. The embodiments described herein employ the following: drawing input, verbal (vocal) input, new uses of graphics, all picture types (including GIF animations), video, gestures, 3-D and user-defined recognized objects.

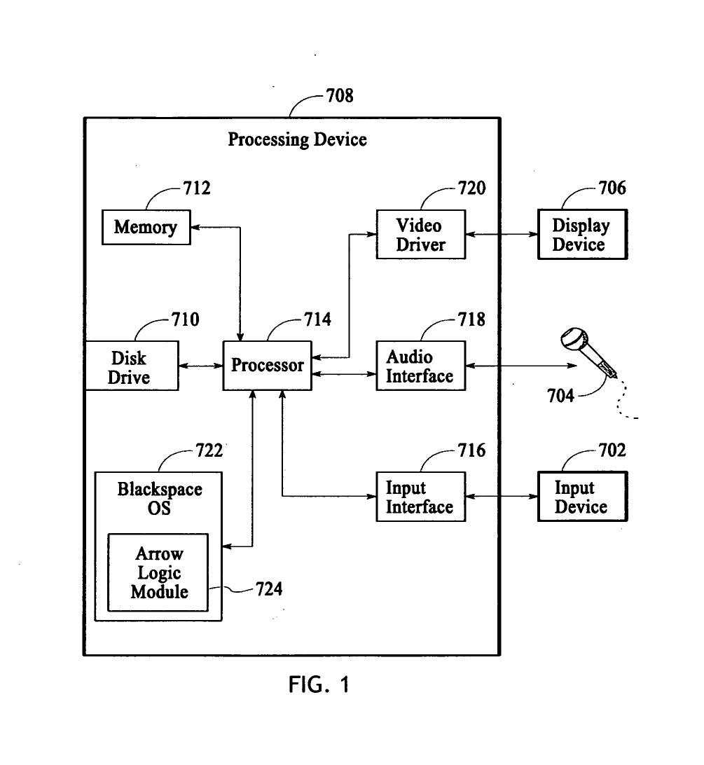

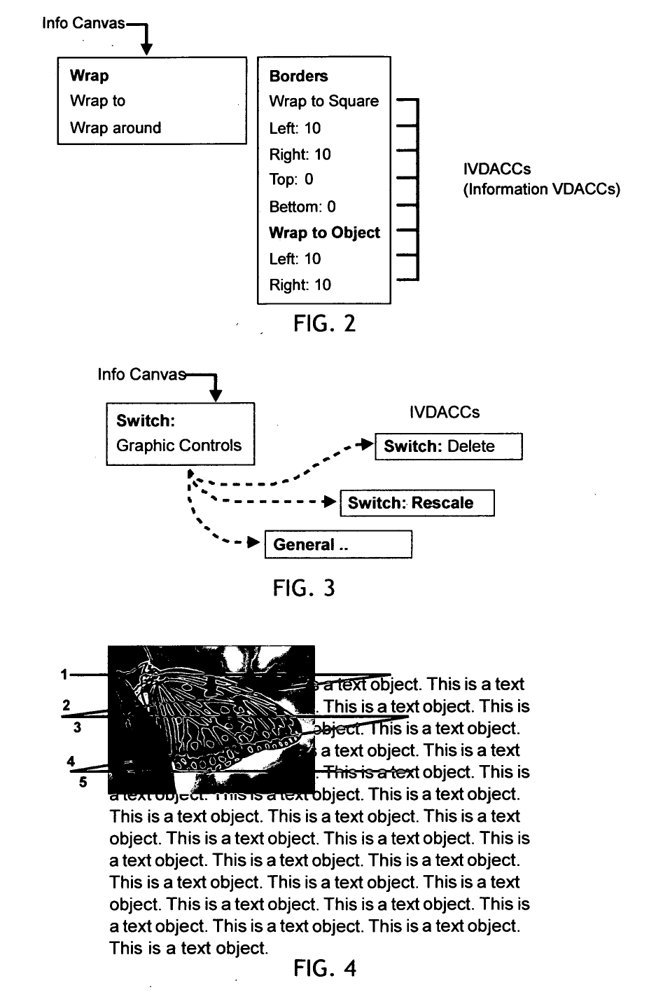

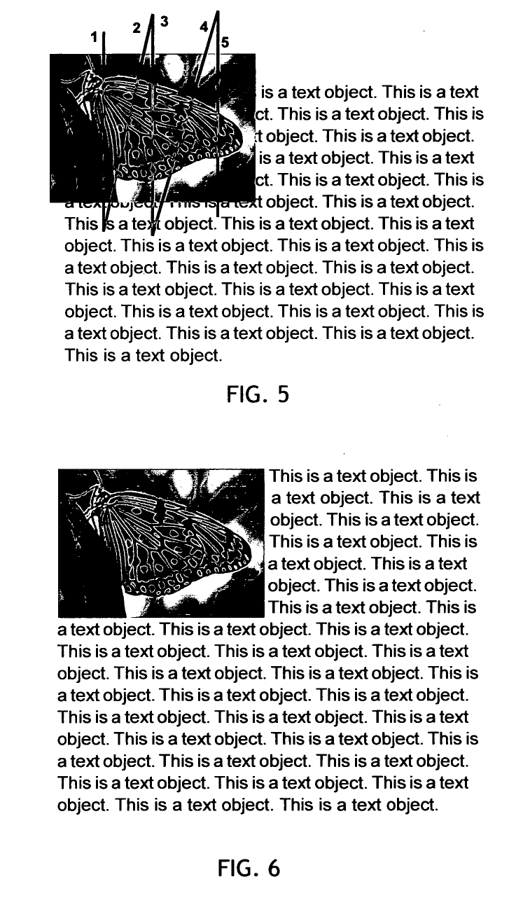

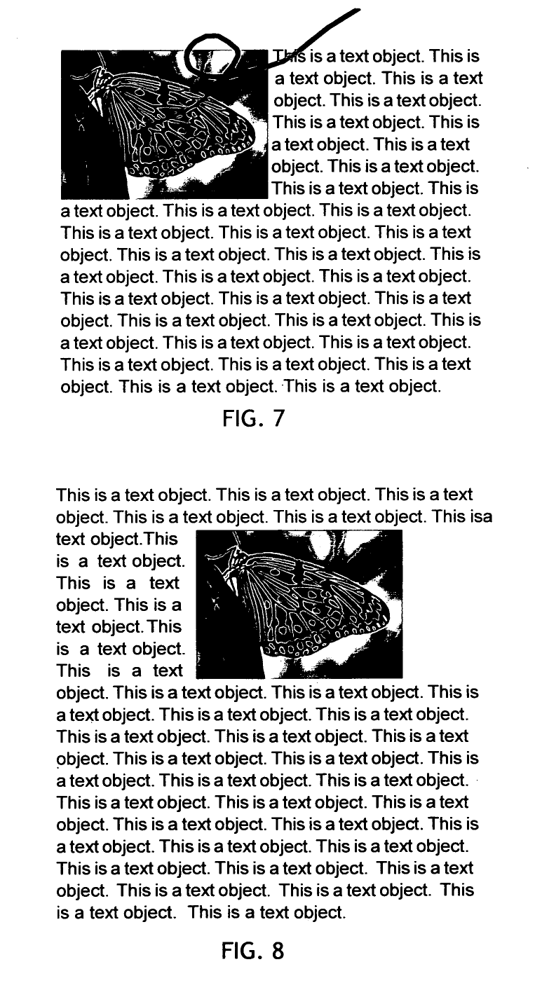

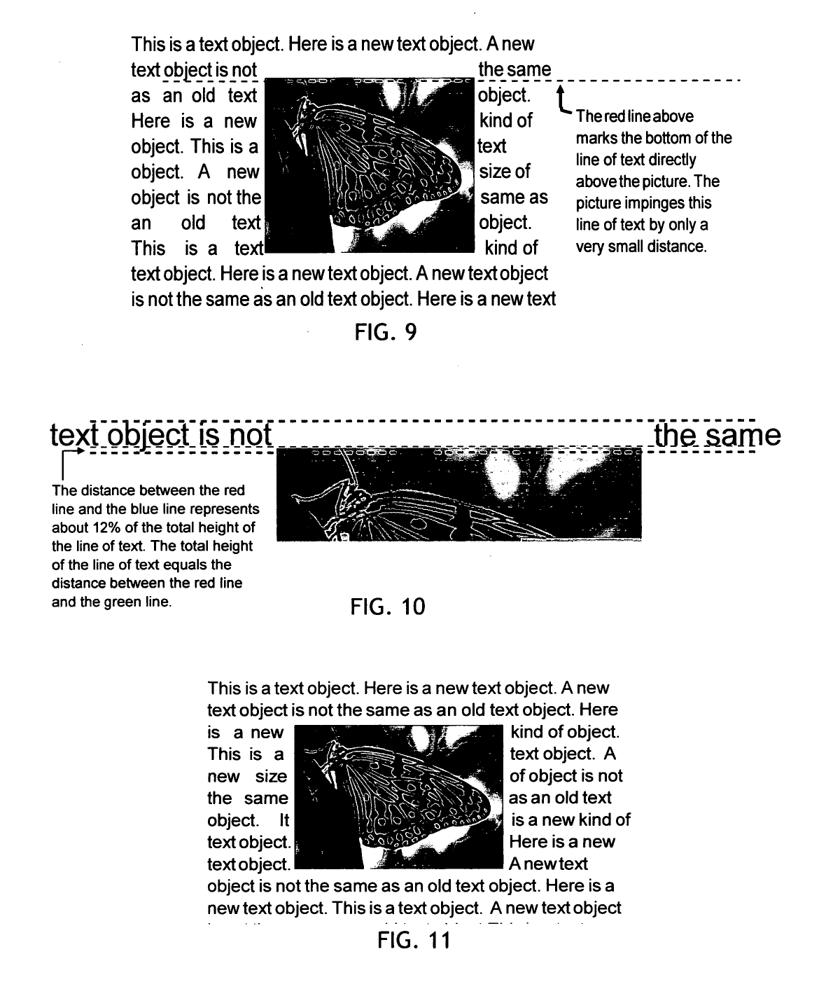

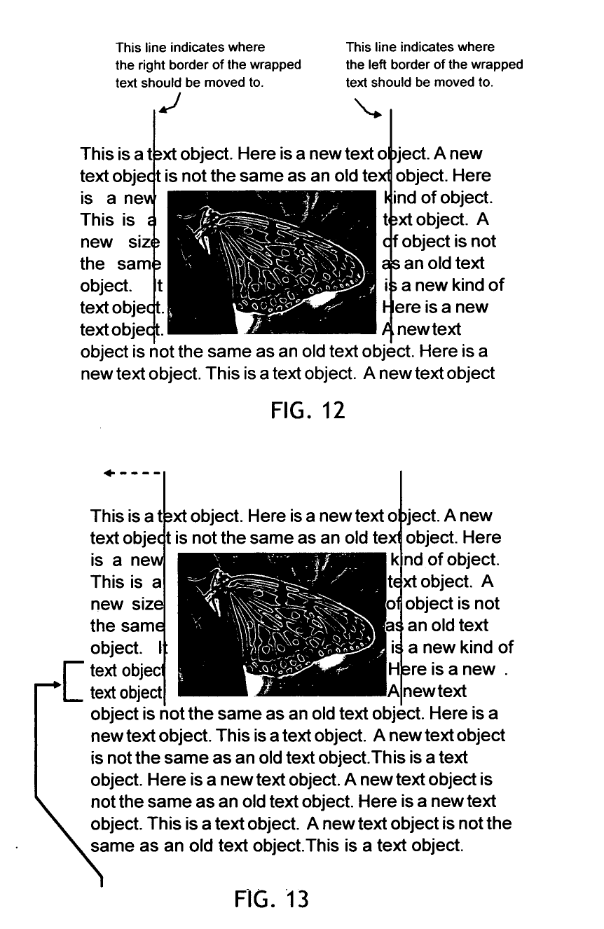

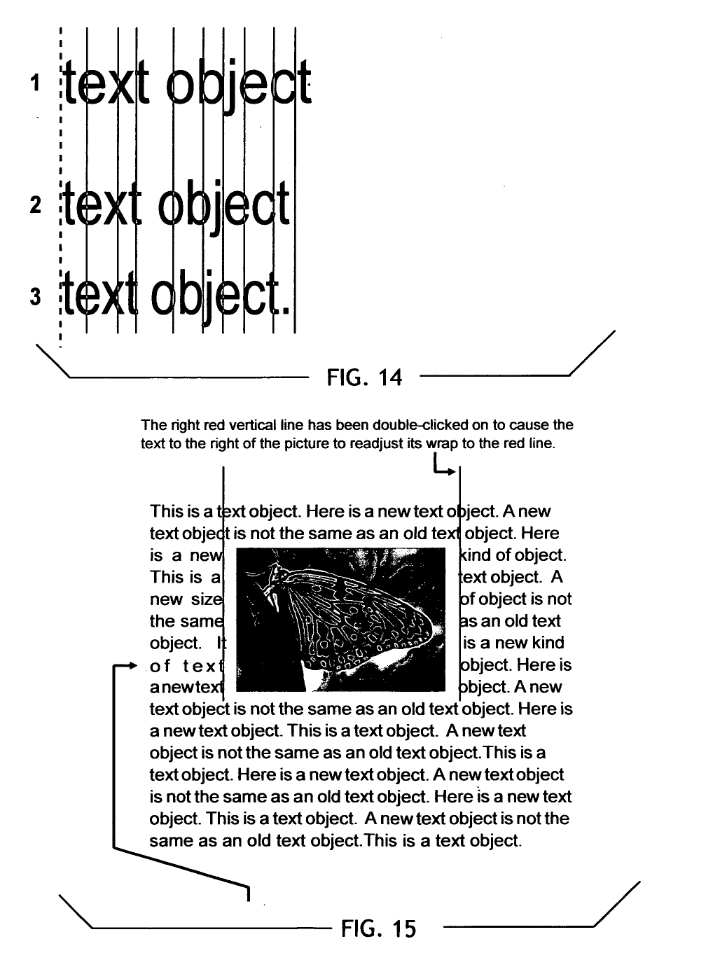

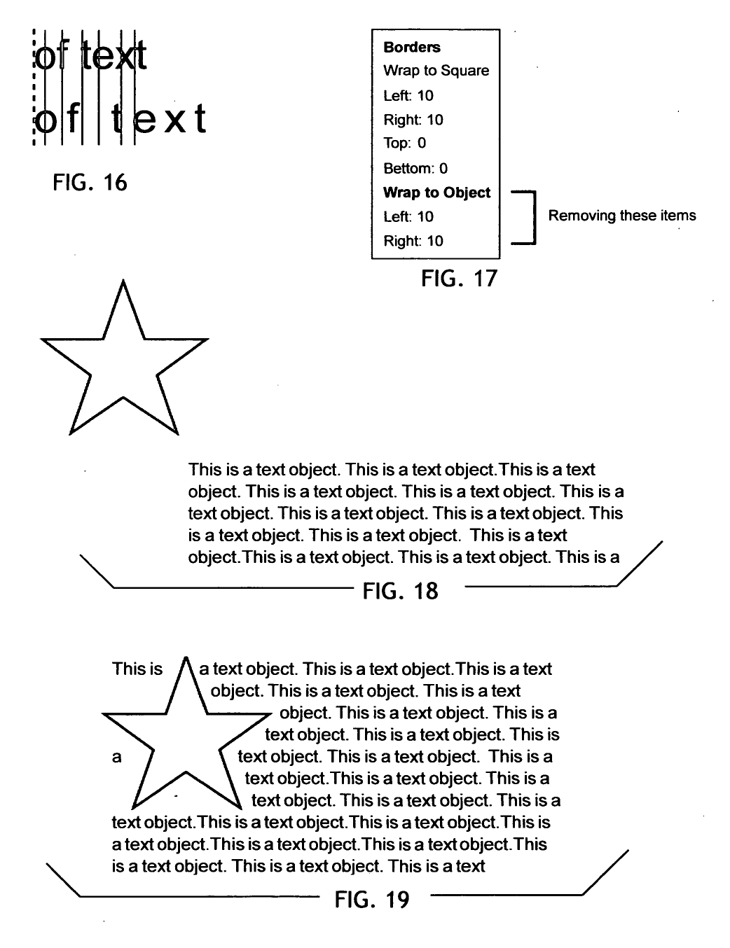

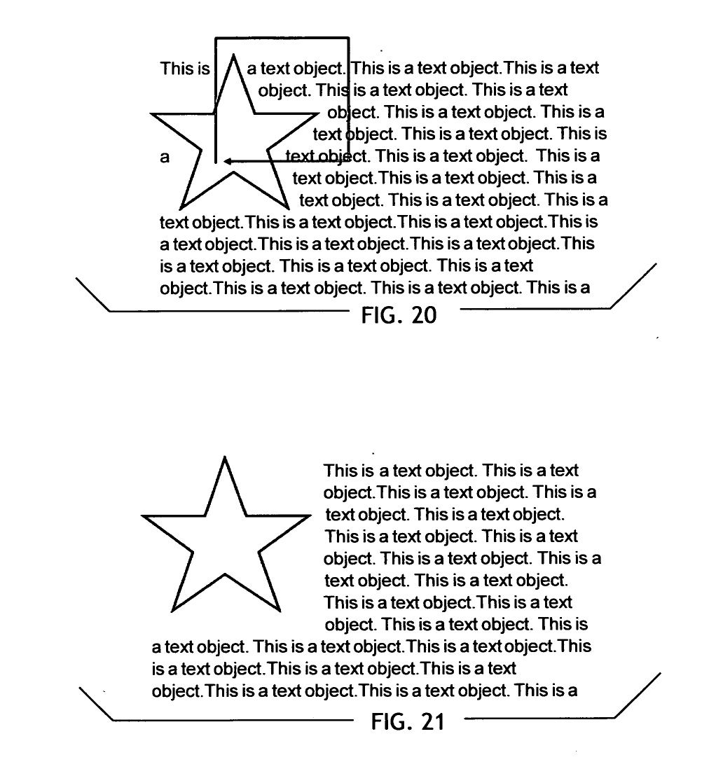

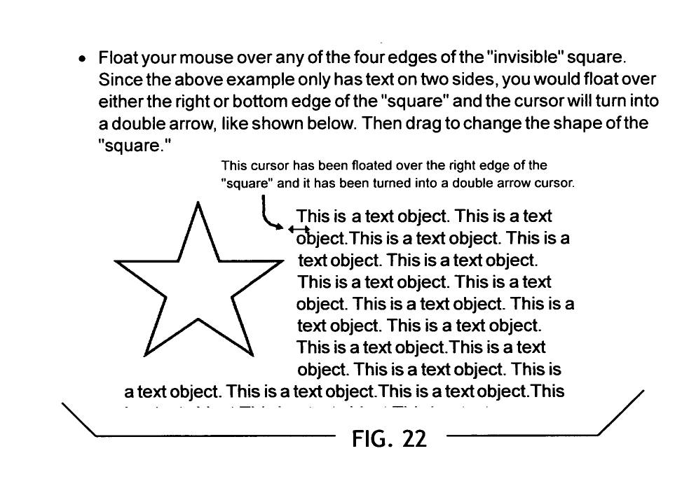

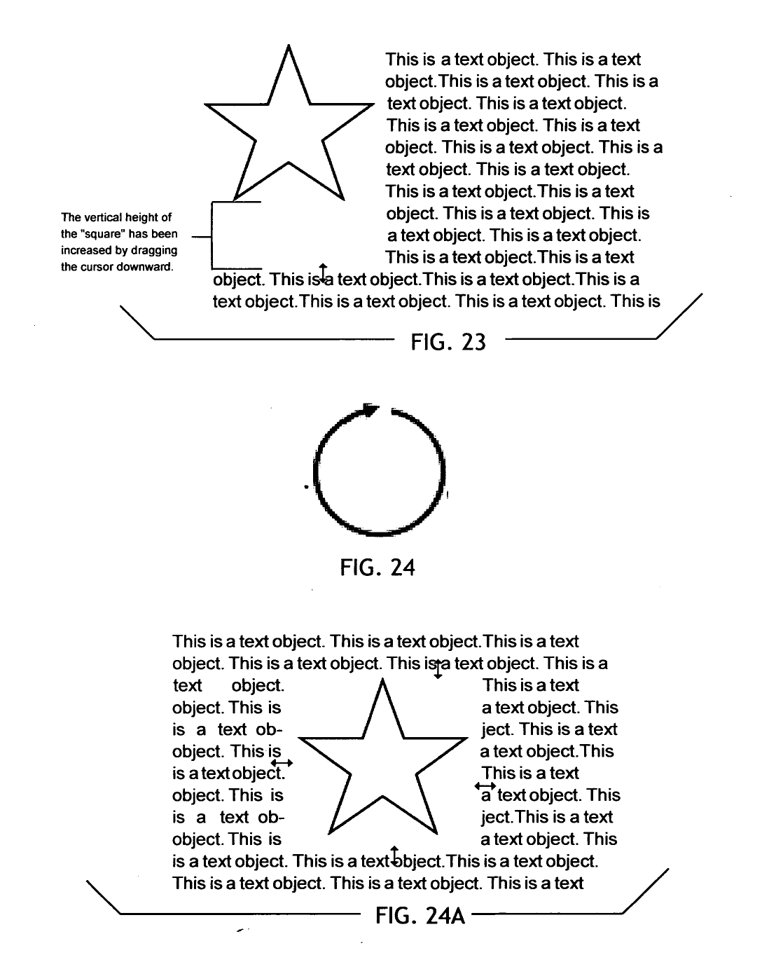

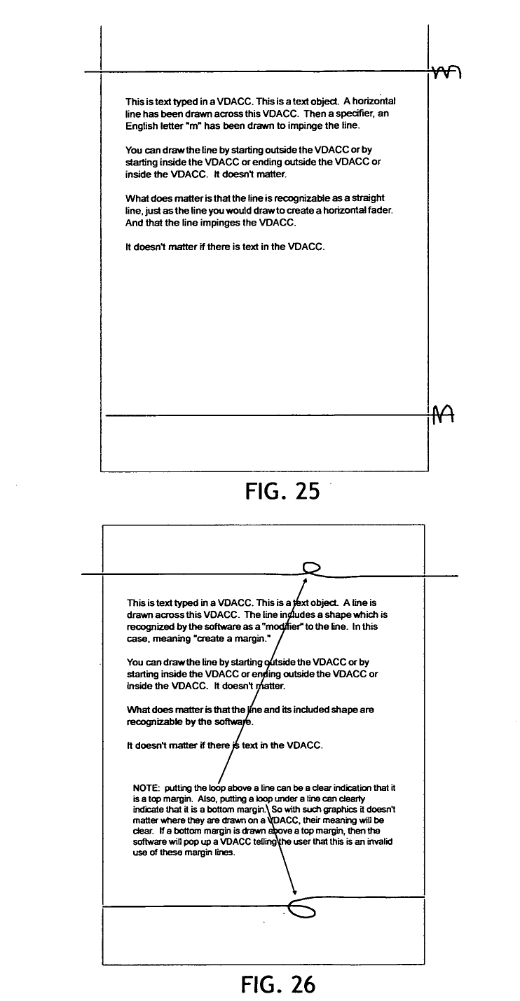

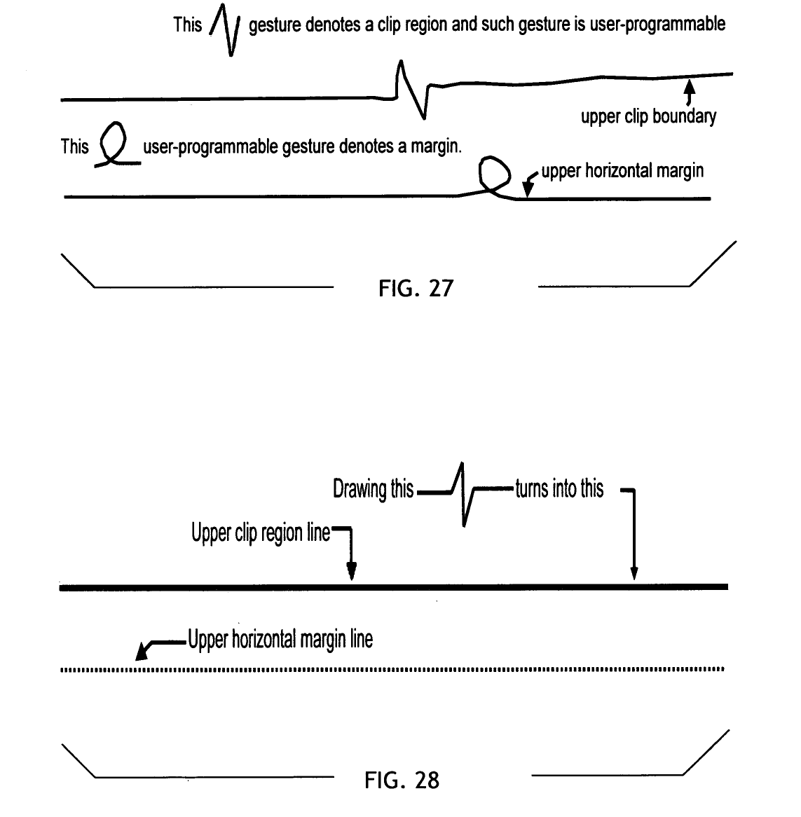

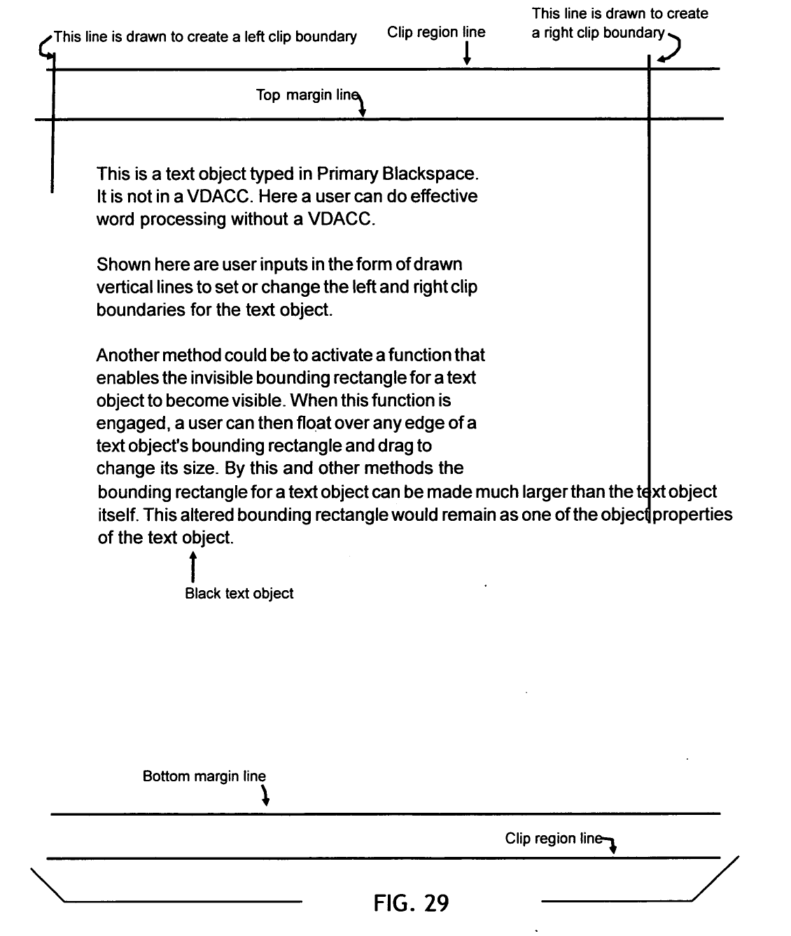

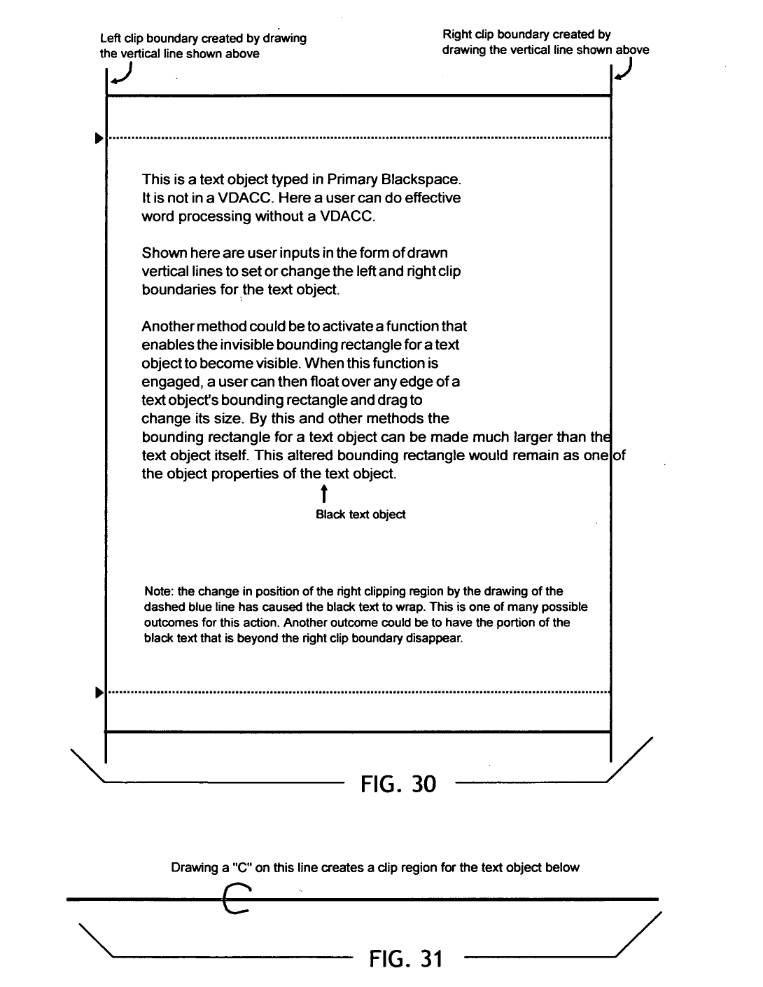

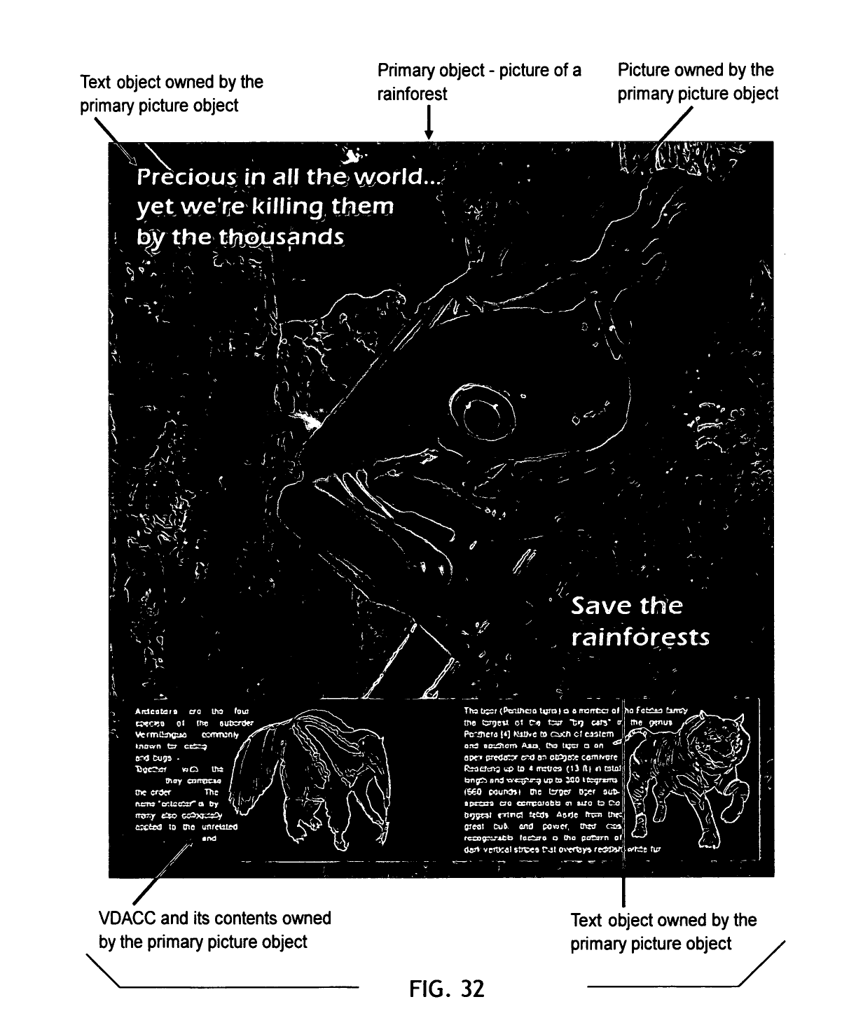

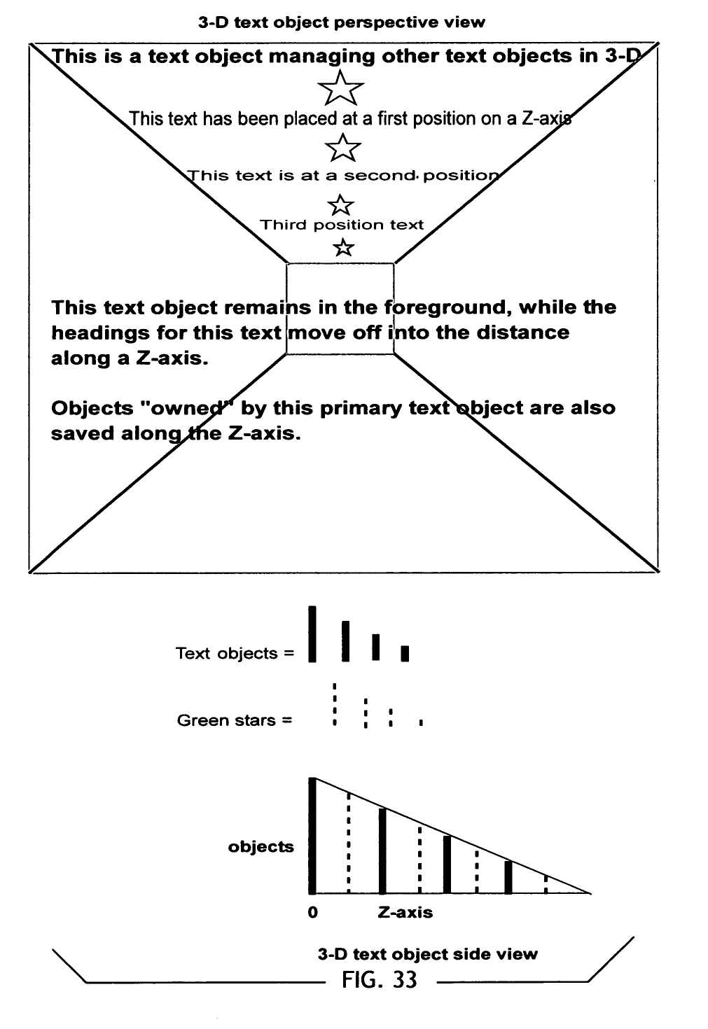

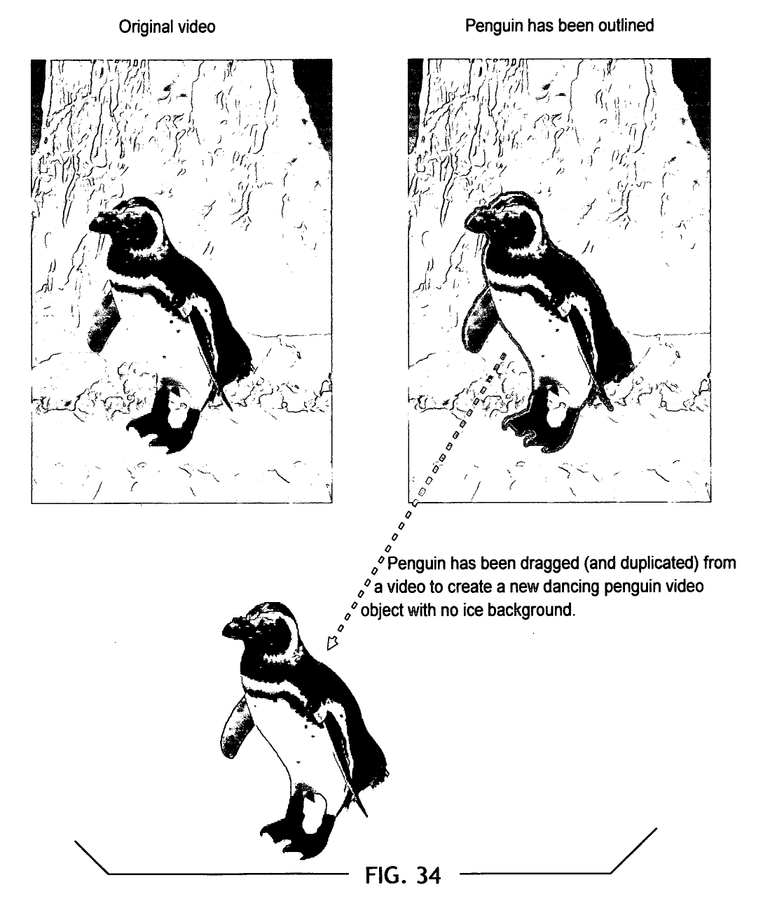

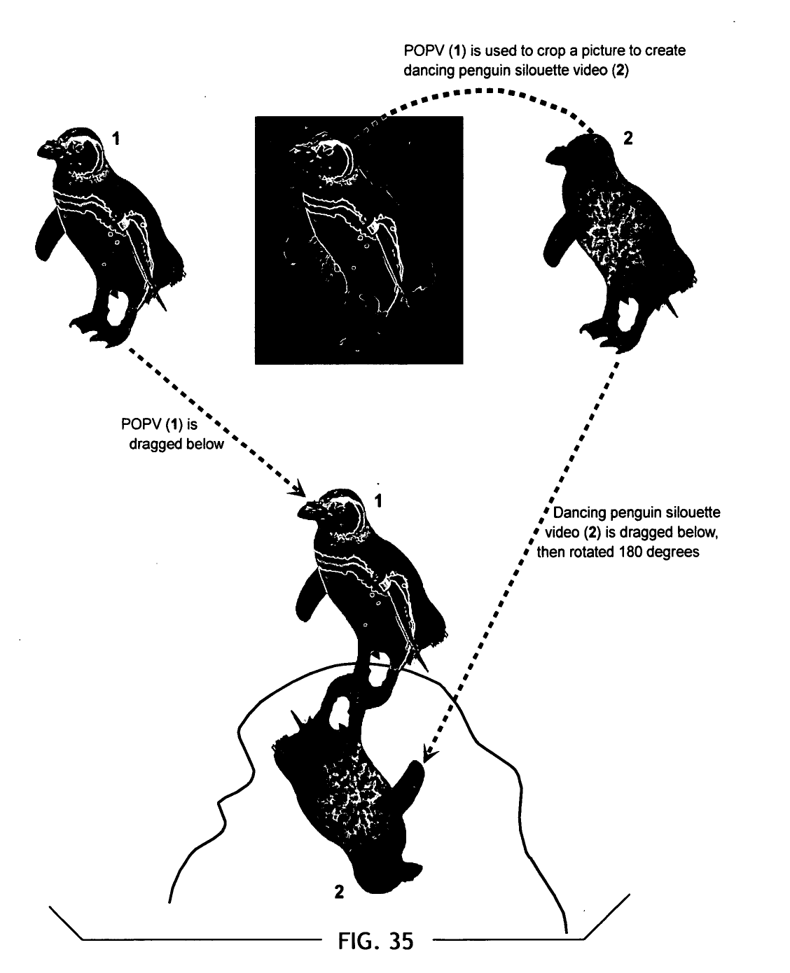

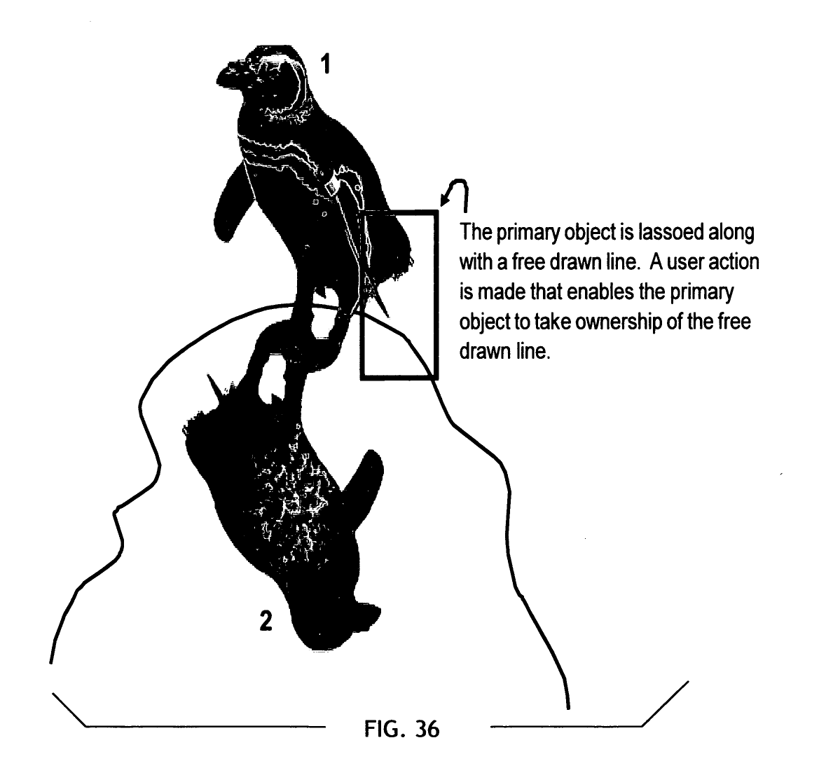

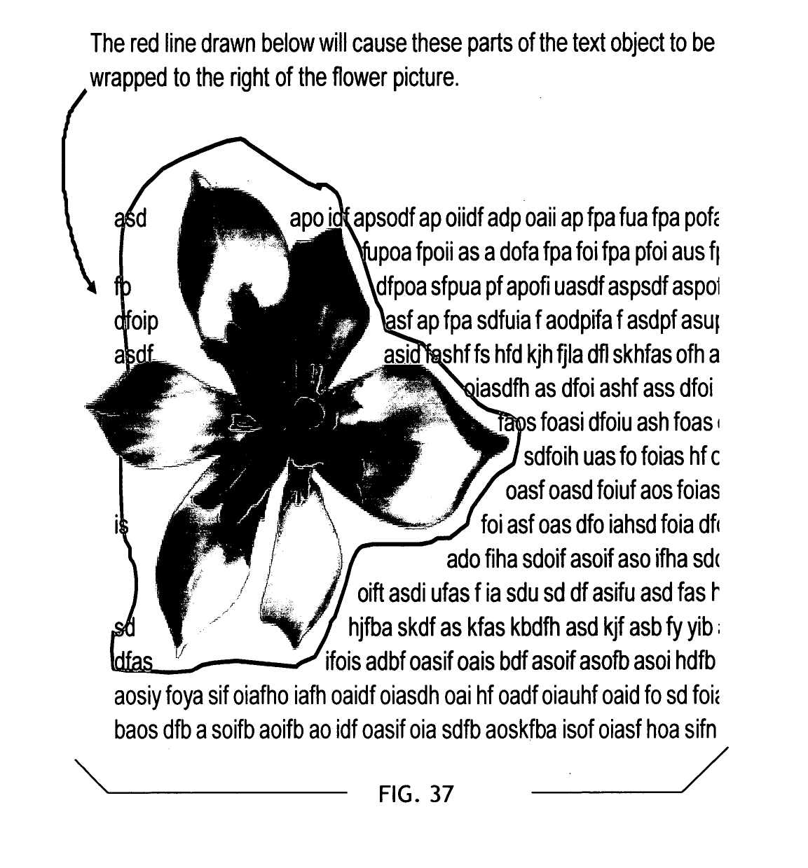

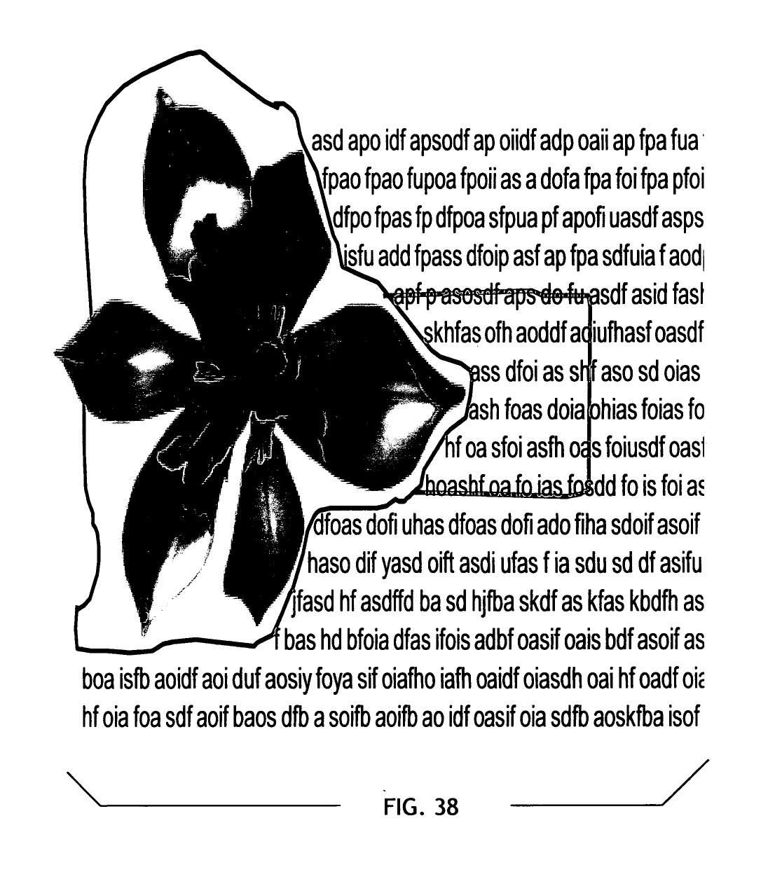

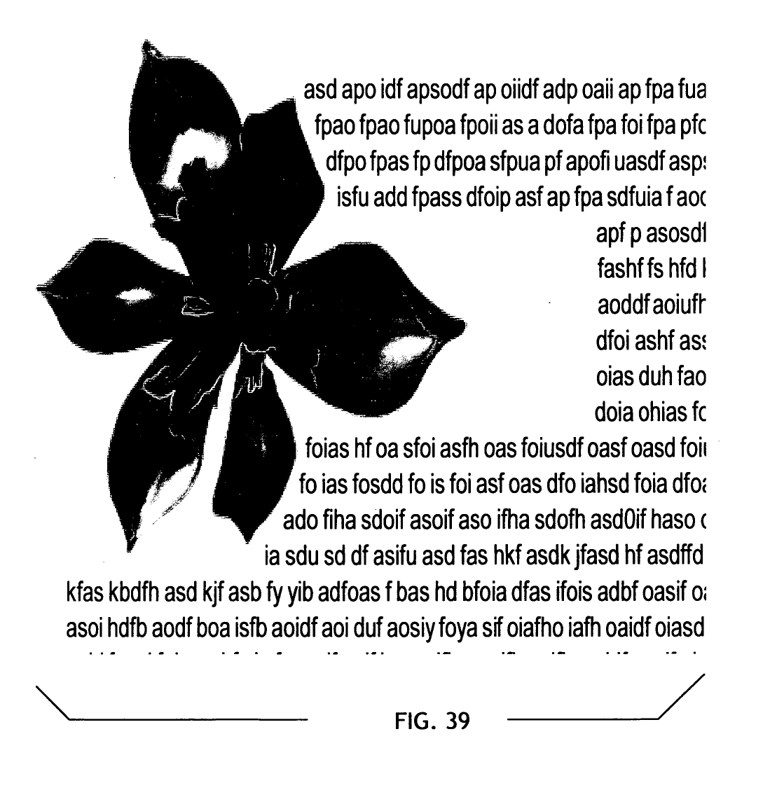

As illustrated in FIG. 1, the computer system for providing the computer environment in which the invention operates includes an input device 702, a microphone 704, a display device 706 and a processing device 708. Although these devices are shown as separate devices, two or more of these devices may be integrated together. The input device 702 allows a user to input commands into the system 700 to, for example, draw and manipulate one or more arrows. In an embodiment, the input device 702 includes a computer keyboard and a computer mouse. However, the input device 702 may be any type of electronic input device, such as buttons, dials, levers and/or switches on the processing device 708. Alternatively, the input device 702 may be part of the display device 706 as a touch-sensitive display that allows a user to input commands using a finger, a stylus or devices. The microphone 704 is used to input voice commands into the computer system 700. The display device 706 may be any type of a display device, such as those commonly found in personal computer systems, e.g., CRT monitors or LCD monitors.

The processing device 708 of the computer system 700 includes a disk drive 710, memory 712, a processor 714, an input interface 716, an audio interface 718 and a video driver 720. The processing device 708 further includes a Blackspace Operating System (OS) 722, which includes an arrow logic module 724. The Blackspace OS provide the computer operating environment in which arrow logics are used. The arrow logic module 724 performs operations associated with arrow logic as described herein. In an embodiment, the arrow logic module 724 is implemented as software. However, the arrow logic module 724 may be implemented in any combination of hardware, firmware and/or software.

The disk drive 710, the memory 712, the processor 714, the input interface 716, the audio interface 718 and the video driver 60 are components that are commonly found in personal computers. The disk drive 710 provides a means to input data and to install programs into the system 700 from an external computer readable storage medium. As an example, the disk drive 710 may a CD drive to read data contained therein. The memory 712 is a storage medium to store various data utilized by the computer system 700. The memory may be a hard disk drive, read-only memory (ROM) or other forms of memory. The processor 714 may be any type of digital signal processor that can run the Blackspace OS 722, including the arrow logic module 724. The input interface 716 provides an interface between the processor 714 and the input device 702. The audio interface 718 provides an interface between the processor 714 and the microphone 704 so that use can input audio or vocal commands. The video driver 720 drives the display device 706. In order to simplify the figure, additional components that are commonly found in a processing device of a personal computer system are not shown or described.

FIG. 2 illustrates typical menus that pull down or pop up, these menus being IVDACC objects. An IVDACC object is a small VDACC object (Visual Display and Design Canvas) that comprises an element of an Info Canvas. An Info Canvas is made up of a group of IVDACCs which contain one or more entries used for programming objects. It is these type of menus and/or menu entries that this invention replaces with graphic gesture entries for the user, as shown in FIG. 3.

FIG. 4 illustrates a text object upon which is placed a picture (of a butterfly), the goal being to perform text wrap around the picture without using a menu. Method to remove the need for the “Wrap” sub-category and “wrap to” and “Wrap around” entries. After the picture is placed over the text, the user shakes the picture left to right 5 times in a “scribble type” gesture, or shakes the picture up and down 5 times in a “scribble type” gesture (FIG. 5) to command the text wrap function, resulting in a text wrap layout as shown in FIG. 6. The motion gesture of “shaking” the picture invokes the “wrap” function and therefore there is no need for the IVDACC entry “wrap around.” When there is a mouse up click (release the mouse button after shaking the picture or lift up the pen or finger) the picture is programmed with “textwrap”. In Blackspace it is as though the user just selected “wraparound” under the sub-category “Wrap”.

FIG. 7 illustrates removing text wrap for an object with text wrap engaged This embodiment uses a “gesture drag” to turn off “wrap around”, “wrap to” and the like for an object. The gesture drag is shown as a red line. A user drags an object that has wrap turned “on” along a specific path—which can be any recognizable shape. Such a shape is shown by the red line below. Dragging an object, like a picture, for which text wrap is “on” in this manner would turn “off” text wrap for that object. Thus dragging the picture along the single looped path shown by the red arrow causes “wrap” to be turned off for the picture. “Shake” the picture again, as described above, and “wrap” will be turned back on (FIG. 8). Any drag path (also known as motion gesture) that is recognized by software as designating the text wrap function to be turned off can be programmed into the system.

FIG. 9 illustrates a method for Removing the “Wrap to Object” sub-category and menus. First, “wrap” has only two border settings, a left and a right border. The upperand lower borders are controlled by the leading of the text itself. Notice the text wrapped around the picture above: there is more space above the picture than below it. This is because the picture just barely intersects the lower edge of the line of text above it. But this intersection causes the line of text to wrap to either side of the picture. This is not desirable, as it leaves a larger space above the picture than below.

One solution is to rescale the picture's top edge just enough so the line of text above the picture does not wrap. A far better solution would be for the software to accomplish this automatically. One way to do this is for the software to analyze the vertical space above and below any object wrapped in text. If a space, like what is shown above, is produced, namely, the object just barely impinges the lower edge of a line of text, then the software would automatically adjust the vertical height of the object to a position that does not cause the line of text to wrap around the object. A user-adjustable maximum distance could be used to determine when the software would engage this function. For instance if a picture (wrapped in a text object) impinges the line of text above it by less than 15%, this software feature would be automatically engaged. The height of the picture would be reduced and the line of text directly above the picture would no longer wrap around the picture.

FIG. 10 shows the picture and top two lines of text from the previous example. They have been increased in size for easier viewing. The red dashed line indicates the lower edge of the line of text directly above the picture. The picture impinges this by a very small distance. This distance can be represented as a percentage of the total height of the line of text. Below a dark green line has been added to show the top edge of the line of text. A blue line has been drawn along the top edge of the picture. The distance between the blue line and the red line equals the amount that the picture is impinging the line of text. (FIG. 10.) This can be represented as a percentage of the total height of the line of text, which is about 12%. This percent can be used by the software to determine when it will automatically rescale a graphical object that is wrapped in a text object to prevent that graphical object from causing a line of text to wrap when the graphical object only impinges that line of text by a certain percentage. This percentage can be user-determined in a menu or the like. The picture (from the above example) adjusted in height by software to create an even upper and lower boundary between the picture and the text in which it is wrapped, is shown in FIG. 11.

FIGS. 12 and 13 illustrate replacing the “left 10” and “right 10” entries for “Wrap.” Draw a vertical line of any color to the right and/or left of a picture that is wrapped in a text object. These one or more lines will be automatically interpreted by the software as border distances. The context enabling this interpretation is:

(1) Drawing a vertical line (preferably drawn as a perfectly straight line—but the software should be able to interpret a hand drawn line that is reasonably straight—like what you would draw to create a fader).
(2) Having the drawn line intersect text that is wrapped around at least one object or having the drawn line be within a certain number of pixels from such an object. Note: (3) below is optional.
(3) Having the line be of a certain color. This may not be necessary. It could be determined that any color line drawn in the above two described contexts will comprise a reliably recognizable context. The use of a specific color (i.e., one of the 34 Onscreen Inkwell colors) is that this would distinguish a “border distance” line from just a purely graphical line drawn for some other purpose along side a picture wrapped in text.
Once the line is drawn and an upclick is performed, the software will recognize the line as a programming tool and the text that is wrapped on the side of the picture where the line was drawn will move its wrap to the location marked by the line. As an alternate a user action could be required, for example, dragging the line at least one pixel or double-clicking on the line in enable the text to be rewrapped by the software.

FIG. 12 shows two red vertical lines drawn over a text object. The line to the left of the picture indicates where the right border of the wrapped text should be. The line to the right of the picture indicates where the left border of the wrapped text should be. In FIG. 113, a user action is requires to invoke the rewrapping of text. This is accomplished by either dragging one of the red vertical lines or by double-clicking on it. Once the software recognizes the drawn vertical lines as tools, the lines can be clicked on and dragged to the right or left or up or down.

In the example of FIG. 13, the left red vertical line has been dragged one pixel. This has cause the text to the left of the picture to be rewrapped. Notice these two lines of text to the left of the picture. They both read “text object.” This is another embodiment of this software. When the text wrap was readjusted to the left of the picture, this caused a problem with these lines. The words “text object” would not fit in the smaller space that was created between the left text margin and the left edge of the picture. So these two phrases (text space) were automatically rescaled to fit the allotted space. In other words, the characters themselves and the spaces between the characters were horizontally rescaled to enable this text to look even but still fit into a smaller space.

FIG. 14 is a more detailed comparison between the original text “1” and the rescaled text, “2” and “3”. The vertical blue line marks the leftmost edge of the text. The vertical red lines extend through the center of each character in the original text and then extend downward through both rescaled versions of the same text. Both the individual characters and the spaces between the characters for “2” and “3” have been rescaled by the software to keep the characters looking even, but still fitting them into a smaller horizontal space. Note: the resealing of the text as explained above, could be the result of a user input. For instance, if the left or right vertical red line were moved to readjust the text wrap some item could appear requiring a user input, like a click or verbal utterance or the like.

FIG. 15 shown the result of activating the right vertical red line to cause the rewrap of the text to the right of the picture. This represents a new “border” distance. Notice the characters “of text.” Using the words “of text” here would leave either a large space between the two words: “of text” or leave a large space between the end of the word “text” and the left edge of the picture. Neither is a desirable solution to achieving good looking text.

To fix this problem the software automatically (or by user input) rescales these words by elongating each individual character and increasing the space between the text (the kerning). One benefit to this solution is that the increase in kerning is not done according to a set percentage. Instead it is done according to the individual widths of the characters. So the rescaling of the spaces between these characters can be non linear. In addition, the software maintains the same weight of the text such that it matches the text around it. When text is resealed wider, it usually increases in weight (the line thickness of the text increases). This makes the text appear bulkier and it no longer matches the text around it. This is taken into account by the software when it rescales text and as part of the rescaling process the line thickness of the resealed text remains the same as the original text in the rest of the text object. (FIG. 16.)

With regard to FIG. 17, the VDACC menu Borders is shown, and the following examples illustrate techniques within the Gestures environment that eliminate at least four items and replace them with gesture equivalents. Consider the star and text object of FIG. 18, and place the star in the text object with text wrap by shaking the image up and down 5 times, resulting in the text wrapped layout of FIG. 19. Notice that this is not a very good text wrap. Since the star has uneven sides the text wrap is not easily anticipated or controlled with a simple “wrap around” type text wrap. One remedy to this problem is “Wrap to Square.” This places an invisible bounding rectangle around the star object and wraps the text to the bounding rectangle.

To accomplish this without resorting to menu (IVDACC) entries, drag the object (for which “wrap to square” is desired) in the rectangular motion gesture (drag path) over the text object (FIG. 20). The gesture can be started on any side of a rectangle or square. If one is making the gesture with a mouse, it would left click and drag the star in the shape shown above. If using a pen, one could push down the tip of the pen (or your finger) on the star and drag it in the shape shown above, etc. When one does a mouse upclick, or its equivalent, the text will be wrapped to a square around the object that you dragged in the clockwise rectangular pattern over a text object. This is shown in FIG. 21.

NOTE: When you drag an object, in this case a star, in a rectangular gesture, the ending position for the “wrapped to square” object is the original position of the object as it was wrapped in the text before you dragged it to create the “wrap to square” gesture.

FIG. 22 illustrates If you don't like the shape of the “square,” one can do the following: Float the mouse cursor over any of the four edges of the “invisible” square. Since the above example only has text on two sides, one would float over either the right or bottom edge of the “square” and the cursor will turn into a double arrow, like shown below. Then drag to change the shape of the “square.” FIG. 23 shows a method to adjust the height of the wrap square above by clicking on dragging down on the wrap border.

FIG. 24 illustrates a method to display what the exact values of the wrap square edges are. Below are listed some of the ways of achieving this.

(1) Use the circular arrow gesture of FIG. 24 over the star graphic to “show” or “hide” the parameters or other objects or tools associated with the star graphic.
(2) Use a verbal command, i.e., “show border values”, “show values”, etc.
(3) Double click on the star graphic to toggle the parameters on and off.
(4) Use a traditional menu (Info Canvas) with the four Wrap to Squareentries—but this is what we wish to eliminate.
(5) Click on the star graphic and then push a key to toggle between“show” and “hide.”
(6) Float the mouse over any edge of the wrap square and a pop up tooltip appears showing the value that is set for that edge.

FIG. 24A is the same star as shown in the above examples now placed in the middle of a text object. In this case you can float over any of the four sides and get a double arrow cursor and then drag to change the position of that side. Dragging a double arrow cursor in any direction changes the position of the text wrap around the star on that side.

The following examples illustrate eliminating the need for vertical margin menu entries. Vertical margin menu entries (IVDACCs) can be removed by the following means. Use any line OR use a gesture line that Invokes “margins,” e.g., from a “personal objects toolbox.” This could be a line with a special color or line style or both.

Using this line, draw a horizontal line that impinges a VDACC or word processor environment.

Alternatively, draw a horizontal line that is above or below or that impinges a text object that is not in a VDACC. Note: objects that are not in VDACCs are in Primary Blackspace. A simple line can be drawn. Then type or draw a specifier graphic, i.e., the letter “m” for margin. Either draw this specifier graphic directly over the drawn line or drag the specifier object to intersect the line. If a gesture line that invokes margins is used, then no specifier would be needed. Determine if the horizontal line is above or below a first drawn horizontal line. This determination is simply to decide if a drawn horizontal line is the top or bottom margin for a given page of text or text object. There are many ways to this, for example, if there is only one drawn horizontal line, then that could be determined to be the top margin if it is above a point that equal 50% of the height of the page or the height of the text object not in a VDACC. And it will be determined to be a bottom margin if it is below a point that equals 50% of the height of a page or the height of a text

object not in a VDACC. If there is no page then it will be measured according to the text object's height.

If it is desired to have a top margin that is below this 50% point, then a more specific specifier will be needed for the drawn line. An example would be “tm” for “top margin,” rather than just “m.” Or “bm” or “btm” for bottom margin, etc. Note: The above described items would apply to one or more lines drawn to determine clipping regions for a text object.

FIG. 25 illustrates a VDACC with a text object in it. A horizontal line is drawn above the text object and impinged with a specifier “m”. This becomes the top vertical margin for this VDACC. Lower on the VDACC a second horizontal line is drawn and impinged with a specifier. This becomes the lower margin. Note: The text that exists in the following examples is informative text and serves in most cases to convey important information about the embodiments herein.

With regard to FIG. 26 instead of drawing a line and then modifying that line by impinging it with a specifier, the line and specifier are drawn as a single stroke. In the example below, a loop has been included as part of a drawn line to indicate “margin.” Note: any gesture or object could be used as part of the line as long as it is recognizable by software. In this example the upward loop in the line indicates a top margin and the downward loop indicates a bottom margin.

FIG. 27-28 shows a text object presented in Primary Blackspace (free space) with hand drawn margins. Drawing a line and then drawing a recognized object that modifies it, like a letter or character, is very fast and it eliminates the need to go to a menu of any kind. Below, the top blue line becomes the top vertical margin line for the text below it. Similarly, the bottom blue line becomes the lower vertical

margin line for this same text. This is a text object typed in Primary Blackspace. It is not in a VDACC. This is a change in how text processing works. Here a user can do effective word processing without a VDACC or window. The advantage is that users can very quickly create a text object and apply margins to that text object without having to first create a VDACC and then place text in that VDACC. This opens up many new possibilities for the creation of text and supports a greater independence for text objects. The idea here is that a user can create a text object by typing onscreen and then by drawing lines in association with that text object can create margins for that text object. The association of drawn lines with a text object can be by spatial distance, e.g., default distance saved in software, or a user defined distance, by intersection with the bounding rectangle for a text object whose size is user-definable. In other words, the size of the invisible bounding rectangle around a text object can be altered by user input. This input could be by dragging, drawing, verbal and the like. In addition to the placement of margins, clip regions can become part of a text object's properties. These clip regions would also enable the scrolling of a text object inside its own clip regions, which are now a part of it as a text object.

Creating margins for a text object in Primary Blackspace or its equivalent can be done with single stroke lines. Below is shown a loop in a line to designate “margin”. In this example a line containing an upper loop is a top margin and a line containing a bottom loop is a bottom margin. Also drawn are two clip lines drawn as a line with a as part of the line. In this case the shape means “clip.” This is a text object typed in Primary Blackspace. It is not in a VDACC. Here a user can do effective word processing without a window or without a VDACC object. The advantage is that users can very quickly create a text object with the use of margins without having to first create a VDACC object and then place the text in that VDACC object.

This opens up many new possibilities for the creation of text and supports a greater independence for text. So the idea here is that a user creates a text object by typing or otherwise presenting it in a computer environment and then draws a line above and, if desired, below the text object. The“shape” used in the line determines the action of the line. Thus the recognition of lines by the software is facilitated by using shapes or gestures in the lines that are recognizable by the software. In addition, these gestures can be programmed by a user to look and work in a manner desirable to the user.

FIG. 29 illustrates setting the width of a text object by drawing. Users can drawn vertical lines that impinge a clip region line belonging to (e.g., that is part of the object properties of) a text object. These drawn vertical lines can become horizontal clip region boundaries for this text object and as such, they would be added to or updated as part of the object properties of the text object. These drawn vertical lines are shown below as a red and blue lines. FIG. 30 illustrates the result of the vertical lines drawn in FIG. 29. These new regions are updated as part of the properties of the black text object. The programming of vertical margins could be the same as described herein for horizontal margins.

FIG. 31 depicts a gesture technique for creating a clip region for a text object by modifying a line with a graphic. A “C” is drawn to impinge a line that has been drawn above and below a text object for the purpose of creating an upper and lower clip region for the text object. This is an alternate to the single stroke approach described above. This is a text object presented in Primary Blackspace and programmed with margin lines. In this example, a horizontal line is drawn above and below this text object. The horizontal lines are intersected by a drawn (or typed or spoken) letter “C”. This “C” could be the equivalent of an action, in this example, it is the action “clip” or “establish a clip region boundary.”

The drawing of a recognized modifier object, like the “C” in this example, turns a simple line style into a programming line, like a “gesture line.” The software recognizes the drawing of this line, impinged by the “C”, as a modifier for the text object. The could produce many results. For example, other objects could be drawn, dragged or otherwise presented within the text object's clipping region and these objects would immediately become controlled (managed) by the text object. As another example, if the text object itself were duplicated, these clipping regions could define the size of the text object's invisible bounding rectangle. A wide variety of inputs (beyond the drawing of a “C”) could be used to modify a line such that it can be used to program an object. These inputs include: verbal inputs, gestures, composite objects (i.e., glued objects, or objects in a container of some sort) and assigned objects dragged to impinge a line.

When a clip region is created for a text object this clip region becomes part of the property of that text object and a VDACC is not needed. So there is no longer a separate object needed to manage the text object. The text object itself becomes the manager and can be used to manage other text objects, graphic objects video objects, devices, web objects and the like.

The look of the text object's clip region can be anything. It could look like a rectangular VDACC. Or a simple look would be to just have vertical lines placed above and below the text object. These lines would indicate where the text would disappear as it scrolls outside the text's clip region. Another approach would be to have invisible boundaries appear visibly only when they are floated over with acursor, hand (as with gesturing controls), wand, stylus, or any other suitable control in either a 2-D or 3-D environment.

With regards to top and bottom clip boundaries, it would be feasible for such a text object to have no vertical clip boundaries on its right or left side. The text's width would be entirely controlled by vertical margins, not the edges of a VDACC or a computer environment. If there were no vertical margins, then the “clip” boundaries could be the width of a user's computer screen, or handheld screen, like a cell phone screen.

It is important to set forth how the software knows which objects a text object is managing. Whatever objects fall within a text object's clip region or margins could be managed by that text object. A text object that manages other objects is being called a “primary text object” or “master text object.” If clip regions are created for a primary text object and objects fall outside these clip regions, then these objects would not be managed by the primary text object.

A text object can manage any type object, including pictures, devices (switches, faders, joysticks, etc.), animations, videos, drawings, recognized objects and the like.

Other methods that can be employed to cause a text object to manage other text objects. These methods could include but are not be limited to: (1) lassoing a group of objects and selecting a menu entry or issuing a verbal command to cause the text primary text object to manage these other objects, (2) drawing a line that impinges a text object and that also impinges one or more other objects for which the text object is to take ownership, such line would convey an action, like “control”, (3) impinging a primary text object with an second object that is programmed to cause the primary text object to become a “manager” for a group of objects assigned to such second object.

Text objects may take ownership of one or more other objects. There are many ways for a text object to take ownership of one or more objects. One method discussed above is to enable a text object to have its own clipping regions as part of its object properties. This can be activated for a text object or for other objects, like pictures, recognized geometric objects, i.e., stars, ellipses, squares, etc., videos, lines, and the like. So any object can take ownership of one or more other objects. Therefore, the embodiments herein can be applied to any object. But the text object will used for purposes of illustration.

Definition of object “ownership: This means that the functions, actions, operations, characteristics, qualities, attributes, features, logics, identities and the like, that are part of the properties or behaviors of one object, can be applied to or used to control, affect, create one or more contexts for, or otherwise influence one or more other objects.

For instance, if an object that has ownership of other objects, (“primary object”), is moved, all objects that it “owns” will be moved by the same distance and angle. If a primary object's layer is changed, the objects it “owns” would have their layer changed. If a primary object were resealed, any one or more objects that its owns would be resealed by the same amount and proportion, unless any of these “owned” objects were in a mode that prevented them from being rescaled, i.e., they have “prevent rescale” or “lock size” turned on.

The invention provides methods for activating an object to take ownership of one or more other objects.

Menu: Activate a menu entry for a primary object that enables it to have ownership of other objects.

Verbal command: An object could be selected, then a command could be spoken, like “take ownership”, then each object that is desired to be“owned” by the selected object would in turn be selected.

Lasso: Lasso one or more objects where one of the objects is a primary object. The lassoing of other objects included with a primary object could automatically cause all lassoed objects to become “owned” by the primary object. Alternately, a user input could be used to cause the ownership. One or more objects could be lassoed and then dragged as a group to impinge a primary object.

FIG. 32 illustrates a picture as a primary object could take ownership of other pictures placed on it, thereby enabling a user to easily create composite images. Below is an example of this. The primary object is the picture of the rainforest. The other elements are “owned” by the primary picture object. This approach would greatly facilitate the creation of picture layouts and the creation of composite images.

FIG. 33 shows that permitting objects to take ownership of other objects works very well in a 3-D environment. Below is a text object that has various headings placed along a Z-axis.

FIG. 34 shows videos can be primary objects, as in a video of a penguin on ice. An outline has been drawn around the penguin and it has been duplicated and dragged from its video as an individual dancing penguin video with no background. This dragged penguin video can be “owned” by the original video. In this case, the playback, speed of playback, duplication, dragging, any visual modification for the “primary video” would control the individual dancing penguin. is another illustration of video object ownership. FIG. 35 is the individual dancing penguin video (1) created in the above example. But this time this penguin video has been made a primary object (primary object penguin video=POPV) the POPV has been placed over a picture and used to crop that picture to create a dancing penguin video silhouette (2). At this point playing (1) will automatically play (2) because (1) owns (2). This is because (2) was created by using (1) in a creation process, namely, using (1) to crop a picture to create a silhouette video (2). Next Then (1) and (2) are dragged to a new location. Then (2) is rotated 180 degrees to become the shadow for (1). Since (1) owns (2) clicking on (1) plays (2) automatically. Also, a blue line was drawn to indicate an ice pond. This free drawn line can also be owned by (1). There are various methods to accomplish this as previously described herein.

In FIG. 36 example, the POPV (1) and the blue line are lassoed and then a vocal utterance is made (“take ownership”) and (1) takes ownership of the blue line as shown below. The primary object is lassoed along with a free drawn line. A user action is made that enables the primary object to take ownership of the free drawn line.

### Custom Border Lines.

Some pictures cause very undesirable text wrap because of their uneven edges. However, putting them into a wrap square is not the always the desired look. In these cases, being able to draw a custom wrap border for a picture or other object and edit that wrap border can be used to achieve the desired result.

FIG. 37 is a picture with text wrapped around it. Notice that there are some pieces of text to the left of the picture. These pieces could be rewrapped by moving the picture to the left, but the point of the left flower pedal is already extending beyond the left text margin. So moving the picture to the left may be undesirable. The solution is a custom wrap border, illustrated on the next four Figures.

FIG. 37 illustrates a user can free draw a line around a picture to alter it text wrap. The free drawn line simply becomes the new wrap border for the picture. This line can be drawn such that the pieces of text that are to the left of the flower are wrapped to the right of the flower. Below is the drawing of such a “wrap border line.” Note: if the line is drawn inside the picture's perimeter, the wrap border is determined by the picture's perimeter, but if the line is drawn outside the picture's perimeter, the wrap border is changed to match the location of the drawn line.

FIG. 38 shows a method to alter the custom text wrap line (“border line”) in the example on page 202. The originally drawn border line can be shown by methods previously described. Once the border line is shown, you can alter it by drawing one or more additional lines and appending these to the original border line or directly alter the shape of the existing line by stretching it or rescaling it. Many possible methods can be used to accomplish these tasks For instance, to “stretch” the existing border line, you could click on two places on the line and use rescale to change its shape between the two clicked points. Alternately you could draw an additional line that impinges the existing border line and modifies its shape. This is shown below. The added line can be appended to the originally drawn border line by a verbal utterance, a context (e.g., drawing a new line drawn to impinge an existing border line causes an automatic update), having the additional line be a gesture line programmed with the action “append”, etc. The result is shown in FIG. 39.

FIG. 40 depicts some of the menu and menu entries that are removed and replaced by graphic gestures of this invention. First, the Grid Info Canvas. It contains controls for the over width and height of a grid and the width of each horizontal and vertical square. These menu items can be eliminated by the following methods. Removing the IVDACCs for the overall width and height dimensions of a grid. Float the mouse cursor over the lower right corner of a grid and the cursor turns into a double arrow If you drag outward or inward you will change the dimension of both the width and height of the grid. Float your mouse cursor over the corner of a grid and hold down the Shift key or an equivalent. Then when you drag in a horizontal direction you will change only the width dimension of the grid. If you drag in a vertical direction you will change only the height of the grid. To remove the IVDACCs for the horizontal and vertical size of grid“squares” (or rectangles) that make up a grid. hold down a key, like Alt, then float the mouse cursor over any individual grid “square.” Drag to the right or left to change the width of the “square”. Drag to up or down to change the height of the “square.” See FIGS. 41 and 42.

FIG. 43 illustrates a method for removing the need for the “delete” entry for a Grid. The solution is to scribble over the grid. Some number of back and forth lines deletes the grid, for example, seven back and forth lines.

FIG. 44 illustrates an alternative to adjusting margins for text in a VDACC.

Draw one or more gesture lines that intersect the left edge of a VDACC containing a text object. The gesture line could be programmed with the following action: “Create a vertical margin line.” A gesture object could be used to cause a ruler to appear along the top and left edges of the VDACC. Below, two blue gesture lines have been drawn to cause a top and bottom margin line to appear and a gesture object has been drawn to cause rulers to appear. The result is shown in FIG. 45.

Eliminating the menus for Snap (FIG. 40) is illustrated in FIGS. 46-52. The following methods can be used to eliminate the need for the snap Info Canvas:

Vocal commands.

Engaging snap is a prime candidate for the use of voice. To engage the snap function a user need only say “snap.” Voice can easily be used to engage new functions like, snapping one object to another where the size of the object being snapped is not changed. To engage this function a user could say: “snap without rescale” or “snap, no resize,” etc.

Graphic Activation of a Function.

This is a familiar operation in Blackspace. Using this a user would click on a switch or other graphic to turn on the snap function for an object. This is less elegant than voice and requires either placing an object onscreen or requiring the user to draw an object or enabling the user to create his own graphic equivalent for such object.

Programming Functions by Dragging Objects.

Another approach would be the combination of a voice command and the dragging of objects. One technique to make this work will eliminate the need for all Snap Info Canvases.
1) Issue a voice command, like: “set snap” or “set snap distance” or “program snap distance” or just “snap distance”. Equivalents are as usable for voice commands as they are for text and graphic commands in Blackspace.
2) Click on the object for which you want to program “snap.”
3) Issue a voice command, e.g., “set snap distances.” Select a first object to which this command is to be applied. [Or enable this command to be global for all objects or select an object and then issue the voice command]. Drag a
second object to the first object, but don't intersect the first object. The distance that this second object is from the first object when a mouse upclick
or its equivalent is performed, determines the second object's position in relation to the first object. This distance programs the first object's snap distance.

If the drag of the second object was to a location to the right or left of the first object, this sets the horizontal snap distance for the first object. If the second object was dragged to a location below or above the first object, this sets the vertical snap distance for the first object. Let's say the drag is horizontal. Then if a user drags a third object to a vertical position near the first object, this sets the vertical snap distance for the first object.

Conditions:

User definable default maximum distance—a user preference can exist where a user can determine the maximum allowable snap distance for programming a snap space (horizontal or vertical) for a Blackspace object. So if an object drag determines a distance that is beyond a maximum set distance, that maximum distance will be set as the snap distance.

Change size condition—a user preference can exist where the user can determine if objects snapped to a first object change their size to match the size of the first object or not. If this feature is off, objects of the same type but of different sizes can be snapped to each other without causing any change is the size of either object.

Snapping different object types to each other—a user preference can exist where the user can determine if the snapping of objects of differing types will be allowed, i.e., snapping a switch to a picture or piece of text to a line, etc.

Saving snap distances. There are different possibilities here, which could apply to changing properties for any object in Blackspace.

Automatic save. A first object is put into a “program mode” or “set parameter mode.” This can be done with a voice command, i.e., “set snap space.”Then when a second object is dragged to within a maximum horizontal or vertical distance from this first object and a mouse upclick (or its equivalent) is performed, the horizontal or vertical snap distance is automatically saved for the first object or for all objects of its type, i.e., all square objects, all star objects, etc.

Drawing an arrow to save. In this approach a red arrow is drawn to impinge all of the objects that comprise a condition or set of conditions (a context) for the defining of one or more operations for one or more objects within this context.

In the example below, the context includes the following conditions:
(1) A verbal command “set snap space” has been uttered.
(2) A first object (a magenta square) has been selected immediately following this verbal utterance.
(3) A second and third object have been dragged to determine a horizontal and vertical snap distance for the first object.
   When the arrow is drawn, a text cursor could automatically appear to let the user draw or type a modifier for the arrow. In this case it would be “save.” As an alternate, clicking on the white arrowhead could automatically cause a “save” and there would be no need to type or otherwise enter any modifier for the arrow.

Verbal save command. Here a user would need to tell the software what they want to save. In the case of the example above, the a verbal utterance would be made to save the horizontal and vertical snap distances for the magenta square. There are many ways to do this. Below are two of them.

First Way: Utter the word “save” immediately after dragging the third object to the first to program a vertical snap distance.

Second Way: Click on the objects that represent the programming that you want to include in your save command. For example if you want to save both the horizontal and vertical snap distances, you could click only on the magenta square or on the magenta square and then on the green and orange rectangles that set the snap distances for the magenta square. If you wanted to only save the horizontal snap distance for the magenta square, you could click on the magenta square and then on the green rectangle or only on the green rectangle, as the subject of this save is already the magenta square.

Change Size Condition. A user can determine whether a snapped object must change its size to match the size of the object it is being snapped to or whether the snapped object should retain its original size and not be altered when it is snapped to another object. This can be programmed by the following methods:

Arrow—Draw an arrow to impinge the snap objects and then type, speak or draw an object that denotes the command: “match size” as a specifier of the arrow's action. As with all commands in Blackspace any equivalent that can be recognized by the software is viable here.

Verbal command—Say a command that causes the matching or not matching of sizes for snapped objects, i.e., “match size” or “don't match size.”

Draw one or more Gesture Objects—A gesture line be used to program snap distance. It could consist of two equal or unequal length lines which would be hand drawn and recognized by the software as a gesture line. This would require the following:

(1) A first object exists with its snap function engaged (turned on).
(2) Two lines are drawn of essentially equal length (e.g. that are within 90% of the same length) to cause the action: “change the size of the dragged object to match the first object.” Or two lines of differing lengths are drawn to cause the opposite action.
(3) The two lines are drawn within a certain time period of each other, e.g., 1.5 seconds, in order to be recognized as a gesture object.
(4) Such recognized gesture object is drawn within a certain proximity to a first object with “snap” turned on. This distance could be an intersection or a minimum default distance to the object, like 20 pixels. These drawn objects don't have to be lines. In fact, using a recognized object could be easier to draw and to see onscreen. Below is the same operation as illustrated above, but instead of drawn lines, objects are used to recall gesture lines.

Pop Up VDACC This is a traditional but useful method of programming various functions for snap. When an object is put into snap and a second object is dragged to within an desired proximity of that object, a pop up VDACC could appear with a short list of functions that can be selected.

FIG. 53 illustrates Snapping non similar object types to each other. The snap can accommodate non-similar object types. The following explains a way to change the snap criteria for any object from requiring that a second object being snapped to a first object perfectly match the first object's type. This change would permit objects of differing types to be snapped together. The following gestures enable this.

Drawing to snap dissimilar objects to each other. One method would be to use a gesture object that has been programmed with the action “snap dissimilar type and/or size objects to each other.” The programming of gesture objects is discussed herein. Below a gesture line that equals the action: “turn on snap and permit objects of dissimilar types and sizes to be snapped to each other” has been drawn to impinge a star object. A green gesture line with a programmed action described above has been drawn to impinge a red star object. This changes the snap definition of the star from its default, which is to only permit like objects to be snapped to it, e.g., only star objects, to now permitting any type of object, like a picture, to be snapped to it. The picture object can then be dragged to intersect the star and this will result in the picture being snapped to the star. The snap distance can either be a property of the gesture line or a property of the default snap setting for the star, or set according to a user input.

FIG. 54 illustrates the result of the above example where a picture object has been dragged to snap to a star object. The default for snapping objects of unequal size is that the second object snaps in alignment to the center line of the first object. Shown below a picture object has been snapped horizontally to a star object. As a result, the picture object has been aligned to the horizontal center line of the star object.

FIGS. 55 and 56 illustrate eliminating the Prevent menus known in the prior art and widely used in Blackspace. Prevent by drawing uses a circle with a line through it: a universal symbol for “no” or “not valid” or“prohibited.” The drawing of this object can be used for engaging “Prevent.” To create this object a circle is drawn followed by a line through the diameter of the circle, as shown in FIG. 56. The “prevent object” is presented to impinge other objects to program them with a “prevent” action. To enable the recognition of this “prevent” object, the software is able to recognize the drawing of new objects that impinge one or more previously existing objects, such that said previously existing objects do not affect the recognition of the newly drawn objects.

The software accomplishes this by preventing the agglomeration of newly drawn objects with previously existing objects. One method to do this would be for the software to determine if the time that previously existing objects were drawn is greater than a minimum time, then the drawing of new objects that impinge these previously existing objects will not result in the newly drawn objects agglomerating to the previously drawn objects.

Definition of agglomeration: this provides that an object can be drawn to impinge an existing object, such that the newly drawn object, in combination with the previously existing object (“combination object”) can be recognized as a new object. The software's recognition of said new object results in the computer generation of the new object to replace the two or more objects comprising said combination object. Note: an object can be a line.

Notes for: “Preventing the agglomeration of newly drawn objects on previously existing objects” flow chart.

1. Has a new (first) object been drawn such that it impinges an existing object. An existing object is an object that was already in the computer environment before the first object was presented. An object can be “presented” by any of the following means: dragging means, verbal means, drawing means, context means, and assignment means.
2. A minimum time can be set either globally or for any individual object. This “time” is the difference between the time that a first object is presented (e.g., drawn) and the time that a previously existing object was presented in a computer environment.
3. Is the time that the previously existing object (that was impinged by the newly drawn “first” object) was originally presented in a computer environment greater than this minimum time?
4. Has a second object been presented such that it impinges the first object? For example, if the first object is a circle, then the second object could be a diagonal line drawn through the circle, like this:
5. The agglomeration of the first and second objects with the previously existing object is prevented. This way the drawing of the first and second objects can't agglomerate with the previously existing object and cause it turned into another object.
6. When the second object impinges the first object can the computer recognize this impinging as a valid agglomeration of the two objects?
7. The impinging of the first object with these second object are recognized by the software and as a result of this recognition the software replaces both the first and second objects with a new computer generated object.
8. Can the computer generated object convey an action to an object that it impinges? Note: turning a first and second object into a computer generated object, results in having that computer generated object impinge the same previously existing object that was impinged by the first and second objects.
9. Apply the action that can be conveyed by the computer generated graphic to the object that it is impinging. For instance, if the computer generated object conveyed the action: “prevent,” then the previously existing object being impinged by the compute generated object would have the action “prevent” applied to it.
In this way a recognized graphic that conveys an action can be drawn over any existing object without the risk of any of the newly drawn strokes causing an agglomeration with the previously existing object.

The conditions of this new recognition are as follows:

(1) According to a determination of the software or via user-input, the newly draw one or more objects will not create an agglomeration to any previously existing object.
(2) The drawn circle can be drawn in the Recognize Draw Mode. The circle will be turned into a computer generated circle after it is drawn and recognized by the software.
(3) The diagonal line can be drawn thorough the recognized circle. But if the circle is not recognized, when the circle is intersected by the diagonal line no “prevent object” will be created.
(4) The diagonal line must intersect at least one portion of a recognized circle's circumference line (perimeter line) and extend to some user-definable length, like to a length equal to 90% of the diameter of the circle or to a definable distance from the opposing perimeter of the circle, like within 20 pixels of the opposing perimeter, as shown in FIG. 57.

FIG. 58 illustrates using this “prevent object”, a circle with a line drawn through it would be drawn to impinge any object. If a prevent object is drawn in blank space in a computer environment, like Blackspace, this will engage the Prevent Mode.

Prevent Assignment—to prevent any object from being assigned to another object, draw the “prevent object” to impinge the object. The default for drawing the prevent object to impinge another object can be “prevent assignment,” and the default for drawing the prevent object in blank space could be: “show a list of prevent functions.” Such defaults are user-definable by any known method.

FIG. 58 is a picture that has been put into “prevent assignment” by drawing the prevent object to impinge the picture object.

FIG. 59 illustrates a prevent object drawn as a single stroke object. In this case the recognition of this object would require a drawn ellipse where the bisecting line extends through the diameter of the drawn ellipse.

FIG. 60 illustrates a more complex use of the prevent object. This example uses the drawing of an assignment arrow that intersects and encircles various graphic objects. Each object that is not to be a part of the assignment has a prevent object drawn over it, thus excluding it from the assignment arrow action.

The invention may also remove menus for UNDO function and substitute graphic gesture methods. This is one of the most used functions in any program. These action can be called forth by graphical drawing means. FIGS. 61 and 62 are two possible graphics that can be drawn to invoke undo and redo. The objects shown above are easily drawn to impinge any object that needs to be redone or undone. This arrow shape does not cause any agglomeration when combined with any other object or combination of objects.

Combining graphical means with a verbal command. If a user is required to first activate one or more drawing modes by clicking on a switch or on a graphical equivalent before they can draw, the drawing of objects for implementing software functions is not as efficient as it could be.

A potentially more efficient approach would be to enable users to turn on or off any software mode with a verbal command. Regarding the activation of the recognize draw mode, examples of verbal utterances that could be used are: “RDraw on”—“RDraw off” or “Recognize on”—“Recognize off”, etc.

Once the recognize mode is on, it is easy to draw an arrow curved to the right for Redo and an arrow curved to the left for Undo.

Combining drawing recognized objects with a switch on a keyboard or cell phone, etc. For hand held devices, it is not practical to have software modes switches onscreen. They take up too much space and will clutter the screen thus becoming hard to use. But pushing various switches, like number switches, to engage various modes could be very practical and easy. Once the mode is engaged, in this case, Recognize Draw, drawing an Undo and Redo graphic to impinge any object is easy.

Using programmed gesture lines. As explained herein a user can program a line or other objects that have recognizable properties, like a magenta dashed line, to invoke (or be the equivalent for) any definable action, like Undo or Redo. The one or more actions programmed for the gesture object would be applied to the one or more objects impinged by the drawing of the gesture object.

Multiple UNDOs and REDOs. One approach is to enable a user to modify a drawn graphic that causes a certain action to occur, like an arched arrow to cause Undo or Redo. First a graphic would be drawn to cause a desired action to be invoked. That graphic would be drawn to impinge one or more objects needing to be undone. Then this graphic can be modified by graphical or verbal means. For instance a number could be added to the drawn graphic, like a Redo arrow. This would Redo the last number of actions for that object. In FIG. 63 the green line has been rescaled 5 times, each result numbered serially. In FIG. 64 the graphic resize #2 has bee impinged on by an Undo graphic, the result being the display of graphic #1. Likewise, in FIG. 65 the graphic #1 has been impinged on by a Redo arrow modified with a multiplier “4”. The result is that the line has been redone 4 times, resulting in graphic resize #5 being displayed. With regard to FIG. 66, although Blackspace already has one graphic designated for deleting something (the scribble), an X is widely recognized to designate this purpose as well. As shown in FIG. 67, an X can be programmed as a gesture object to perform a wide variety of functions. Above the Context Stroke is: “Any digital object.” So any digital object impinged by the red X will a valid context for the red X gesture object. The Action Stroke impinges an entry in a menu: “Prevent Assignment.” Thus the action programmed for the red X gesture object is: “Prevent Assignment. Any object that has a red X drawn to impinge it will not be able to be assigned to any other object. To allow the assignment of an object impinged by such a red X, delete the red X or drag it so that it no longer impinges the object desired to be assigned. The Gesture Object Stroke points to a red X. This is programmed to be a gesture object that can invoke the action: “prevent assignment.” To use this gesture object, either draw it or drag it to impinge any object for which the action “prevent assignment” is desired to be invoked.

The removing of menus as a necessary vehicle for operating a computer serves many purposes: (a) it frees a user from having to look through a menu to find a function, (b) whenever possible, it eliminates the dependence upon language of any kind, (c) it simplifies user actions required to operate a computer, and (d) it replaces computer based operations with user-based operations.

Selecting Modes

A. Verbal—Say the name of the mode or an equivalent name, i.e., RDraw, Free Draw, Text, Edit, Recog, Lasso, etc., and the mode is engaged.
B. Draw an object—Draw an object that equals a Mode and the mode is activated.
C. A Mode can be invoked by a gesture line or object. —A gesture line can be drawn in a computer environment to activate one or more modes. A gesture object that can invoke one or more modes can be dragged or otherwise presented in a computer environment and then activated by some user action or context.
D. Using rhythms to activate computer operations—The tapping of a rhythm on a touch screen or by pushing a key on a cell phone, keyboard, etc., or by using sound to detect a tap, e.g., taping on the case of device or using a camera to detect a rhythmic tap in free space can be used to activate a computer mode, action, operation, function or the like.

FIG. 68 illustrates a gesture method for removing the menu for “Place in VDACC.” Placing objects in a VDACC object has proven to be a very useful and effective function in Blackspace. But one drawback is that the use of a VDACC object requires navigating through a menu (Info Canvas) looking for a desired entry.

The embodiment described below, enables a user to draw a single graphic that does the following things:

(a) It selects the objects to be contained in or managed by a VDACC object.
(b) It defines the visual size and shape of the VDACC object.
(c) It supports further modification to the type of VDACC to be created.
A graphic that can be drawn to accomplish these tasks is a rectangular arrow that points to its own tail. This free drawn object is recognized by the software and is turned into a recognized arrow with a white arrowhead. Click on the white arrowhead to place all of the objects impinged by this drawn graphic into a VDACC object.

FIG. 69 illustrates a “place in VDACC” line about a composite photo.

FIG. 70 illustrates Drawing a “clip group” for objects appearing outside a drawn “Place in VDACC” arrow. A “Place in VDACC” arrow has been drawn around three pictures and accompanying text. Below the perimeter of this arrow is another drawn arrow that appends the graphical items that lie outside the boundary of the first drawn “Place in VDACC” arrow to the VDACC that will be created by the drawing of said first arrow. The items impinged by the drawing of the second arrow are clipped into the VDACC created by the drawing of the first red arrow. The size and dimensions of the VDACC are determined by the drawing of the first arrow. The second arrow tells the software to take the graphics impinged by the second arrow and clip them into the VDACC created by the first arrow.

A place in VDACC arrow may be modified, as shown in FIG. 71. The modifier arrow makes the VDACC, that is created by the drawing of the first arrow, invisible. So by drawing two graphics a user can create a VDACC object of a specific size, place a group of objects in it and make the VDACC invisible. Click on either white arrowhead and these operations are completed.

Removing Flip menus. Below are various methods of removing the menus (IVDACCs) for flipping pictures and replacing them with gesture procedures. The embodiments below enable the flipping of any graphic object (i.e., all recognized objects), free drawn lines, pictures and even animations and videos.

Tap and drag—Tap or click on an edge of a graphic and then within a specified time period, like 1 second, drag in the direction that you wish to flip the object. See FIG. 72. See FIG. 73 for other gestures for flip vertical and flip horizontal tasks. Two hand touches on multi-touch screen, the now familiar touch an object with one finger and drag another finger on the same object, can also be used. In this case, one could hold a finger on the edge of an object and then within a short time period drag another finger horizontally (for a horizontal flip) or vertically (for a vertical flip) across the object.

FIG. 74 illustrates an example for text, but this model can be applied to virtually any object. The idea is that instead of using the cursor to apply a gesture, one uses a non-gesture object and a context to program another object. Applying the color of one text object to another text object. If one has a text object that is a custom color that you now want to apply to another text object that is of another color. Click on the first text object and drag it to make a gesture over one or more other text objects. The gesture (drag) of the first text object causes the color of the text objects impinged by it to change to its color. For example, let's say you drag a first text object over a second text object and then move the first text object in a circle over the second object. This gesture automatically changes the color of the second text object to the color of the first. The context here is: (1) a text object of one color, (2) being dragged in a recognizable shape, (3) to impinge at least one other text object, (4) that is of a different color. The first text object is dragged in a definable pattern to impinge a second text object. This action does the following things in this example. It takes the color of the first text object and uses it to replace the color of the second text object. It does this without requiring the user to access an inkwell or eye dropper or enter any modes or utilize any other tools. The shape of the dragged path is a recognized object which equals the action: “change color to the dragged object's color.”

FIG. 75 illustrates Another approach to programming gesture objects would be to supply users with a simple table that they would use to pick and choose from to select the type of gesture and the result of the gesture. As an alternate, users could create their owntables—selecting or drawing the type of gesture object they wish for the left part of the table and typing or otherwise denoting a list of actions that are important to them for the right part of the table. Then the user would just click on a desired gesture object (it could turn green to indicate it has been selected and then click on one or more desired actions in the right side of the table. In the table below a gesture object has been selected in the left table and an action “invisible” has been selected in the right table. Both selections are green to indicate they have been selected.

Filling objects and changing their line color—This removes the need for Fill menus (IVDACCs). This idea utilizes a gesture that is much like what you would do to paint something. Here's how this works. Click on a color in an inkwell then float your mouse, finger, pen or the like over an object in the following pattern. This circular motion feels like painting on something, like filling it in with brush strokes. There are many ways of invoking this: (1) with a mouse float after selecting a color, (2) with a drawn line after selecting a color, (3) with a hand gesture in the air—recognized by a camera device, etc.

The best way to utilize the drawn line is to have a programmed line for “fill” in your personal object toolbox, accessed by drawing an object, like a green star, etc. These personal objects would have the mode that created them built into their object definition. So selecting them from your toolbox will automatically engage the required mode to draw them again. Utilizing this approach, you would click on a “fill” line in your tool box and draw as shown in FIG. 76. The difference between the “fill” and “line color”, gesture is only in where the gesture is drawn. In the case of a fill it is drawn directly to intersect the object. In the case of the line color, it is started in a location that intersects the object but the gesture (the swirl) is drawn outside the perimeter of the object. They are undoubtedly many approaches to be created for this. The ideas above are intended as illustrations only.
Removing the Invisible menu. —Verbal command Say “invisible.” Draw an “i’ over the object you wish to make invisible. The “i” would be a letter that is recognized by the software. The idea here is that this letter can be hand draw in a relative large size, so it's easy to see and to draw and then when it's recognized, the image that is impinged by this hand draw letter is made invisible. (FIG. 77). Then the letter would disappear from view. Programming this gesture line to invoke the action invisible would be simple to create. You would create or recall an object, make it invisible, then draw a Context Stroke to impinge the invisible object (draw through the space where the invisible object is sitting). Then draw an Action Stroke to impinge the same invisible object. Then draw a Gesture Object Stroke pointing to the gesture object you wish to invoke the action “invisible.”

Removing the need for “wrap to edge” menu item for text. This is a highly used action, so more than one alternate to an IVDACC makes good sense. There are two viable replacements for the “wrap to edge” IVDACC. Each serves a different purpose. They are illustrated In FIG. 78. In one, a user draws a vertical “wrap to edge line” in a computer environment. They then type text such that when the text collides with this line it will wrap to a new line of text. This wrap to edge line is a gesture line that invokes the action “wrap to edge” when it is impinged by the typing or dragging of a text object. See FIG. 78.

Vocal command—Wrap to edge can be invoked by a verbal utterance, e.g., “wrap to edge.” A vocal command is only part of the solution here, because if you click on text and say “wrap to edge”, the text has to have something to wrap to. So if the text is in a VDACC or typed against the right side of one's computer monitor where the impinging of the monitor's edge by the text can cause “wrap to edge,” a vocal utterance can be a fast way of invoking this feature for the text object. But if a text object is not situated such that it can wrap to an “edge” of something, then a vocal utterance activating this “wrap to edge” will not be effective. So in these cases you need to be able to draw a vertical line in or near the text object to tell it where to wrap to. This, of course, is only for existing text objects. Otherwise, using the “wrap to edge” line as described under A above is a good solution for freshly typed text. But for existing text, drawing a vertical line through the text and then saying “wrap to edge” or its equivalent would be quite effective.

The software would recognized the vocal command, e.g., “wrap to edge” and then look for a vertical line that is some minimum length (i.e., one half inch) and which impinges a text object.

Removing the IVDACCs for lock functions, such as move lock, copy lock, delete lock, etc. Distinguishing free drawn user inputs used to create a folder from free drawn user inputs used to create a lock object.

Currently drawing an arch over the left, center or right top edge of a rectangle results in the software's recognition of a folder. A modification to this recognition software provides that any rectangle that is impinged by a drawn arch that extends to within 15% of its left and right edges will not be recognized as a folder. Then drawing this will cause the software to recognize a lock object which can be used to activate any lock mode.

There are different ways to utilize the Lock recognized object.

a. Accessing a List of Choices
Draw a recognized lock object, and once it is recognized, click on it and the software will present a list of the available lock features in the software. These features can be presented as either text objects or graphical objects. Then select the desired lock object or text object.
b. Activating a Default Lock Choice.
With this idea the user sets one of the available lock choices as a default that will be activated when the user draws a “lock object” and then drags that object to impinge an object for which they wish to convey the default action for lock. Possible lock actions include: move lock, lock color, delete lock, and the like.

If the software finds these conditions, then it implements a wrap action for the text, such that the text wraps at the point where the vertical line has been drawn. If the software does not find this vertical line, it cannot activate the verbal “wrap to edge” command. In this case, a pop up notice may appear alerting the user to this problem. To fix the problem, the user would redraw a vertical line through the text object or to the right or left of the text object and restate: “wrap to edge.” See FIGS. 79 and 80.

In the above described embodiment, the line does not have to be drawn to intersect the text. If this were a requirement, then you could never make the wrap width wider than it already is for a text object. So the software needs to look to the right for a substantially vertical line. If it doesn't find it, it looks farther to the right for this line. If it finds a vertical line anywhere to the right of the text and that line impinges a horizontal plane defined by the text object, then the verbal command “wrap to text” will be implemented.

Another way to invoke Lock Color would be to drag a lock object through the object you want to lock the color for and then drag the lock to intersect an inkwell. Below a lock object has been dragged to impinge two colored circle objects and then dragged to impinge the free draw inkwell. This locks the color of these two impinged objects.

Verbal commands This is a very good candidate for verbal commands. Such verbal commands could include: “lock color,”, “move lock”, “delete lock,” “copy lock,” etc.

Unique recognized objects. These would include hand drawn objects that would be recognized by the software. FIG. 82 shows an example of such an object to that could be used to invoke “move lock.”

Creating user-drawn recognized objects. This section describes a method to “teach” Blackspace how to recognize new hand drawn objects. This enables users to create new recognized objects, like a heart or other types of geometric objects. These objects need to be easy to draw again, so scribbles or complex objects with curves are not good candidates for this approach. What are good candidates are simple objects where the right and left halves of the object are exact matches.

This carries with it two advantages: (1) the user only has to draw the left half of the object, and (2) the user can immediately if their hand drawn object ha been recognized by the software. Here's how this works. A grid appears onscreen when a user selects a mode which can carry any name. Let's call it: “design an object.” So for instance, a user clicks on a switch labeled “design an object” or types this text or its equivalent in Blackspace, clicks on it and a grid appears. This grid has a vertical line running down its center. The grid is comprised of relatively small grid squares, which are user-adjustable. This smaller squares (or rectangles) are for accuracy of drawing and accuracy of computer analysis.

The idea is this. A user draws the left half of the object they want to create. Then when they lift off their mouse (do an upclick or its equivalent) the software analyzes the left half of the user-drawn object and then automatically draws the second half of the object on the right side of the grid.

The user can see immediately if the software has properly recognized what they drew. If not, the user will probably need to simplify their drawing or draw it more accurately.

For these new objects to have value to a user as operational tools, whatever is drawn needs to be repeatable. The idea is to give a user unique and familiar recognized objects to use in as tools in computer environment. So these new objects need to have a high degree of recognition accuracy.

FIG. 83 is an example of a grid that can be used to enable a user to draw the left side of an object. On this grid a half “heart object” has been drawn by the user. The software has then analyzed the user's drawing and has drawn a computer version of it on the right side of the grid. The user can immediate see if the software has recognized and successfully completed the other half of their drawing by just looking at the result on the grid. If the other half is close enough, then the user enters one final input. This could be in the form of a verbal command, like, “save object” or “create new object,” etc.

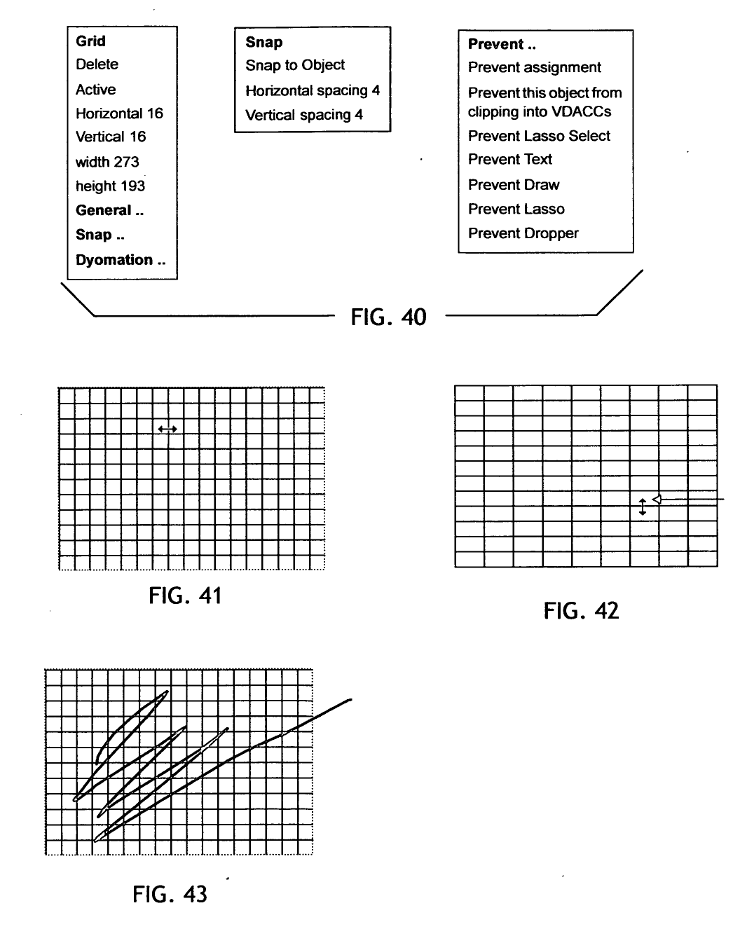

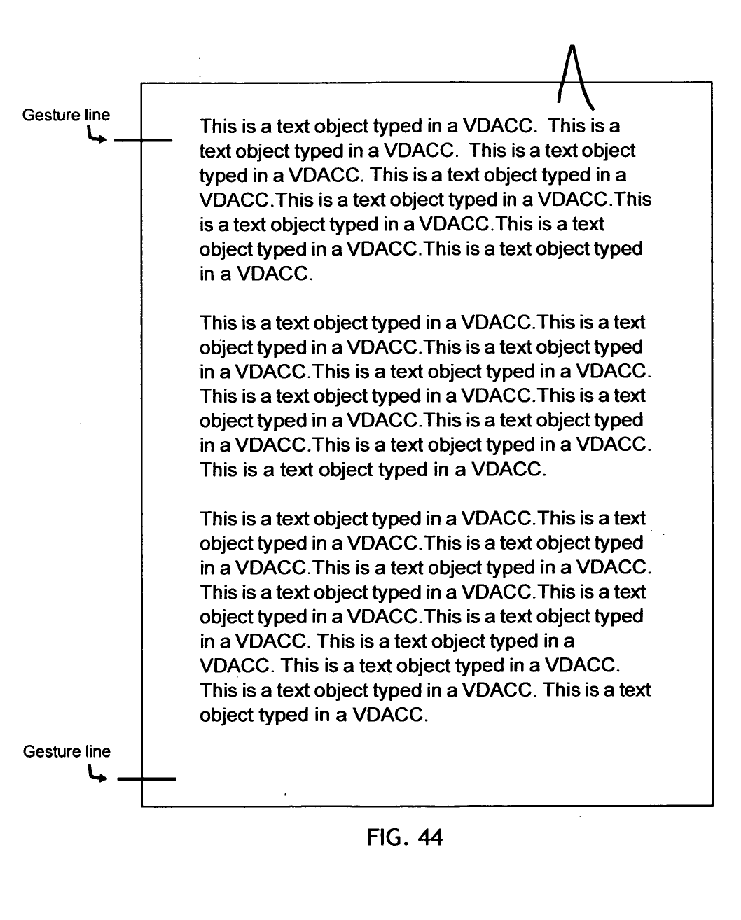

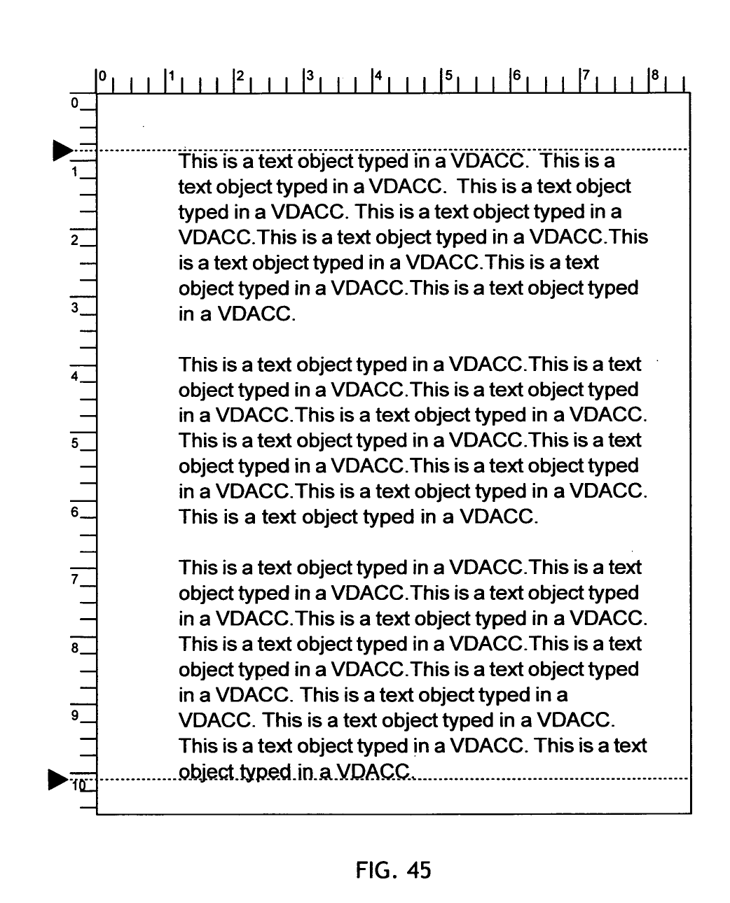

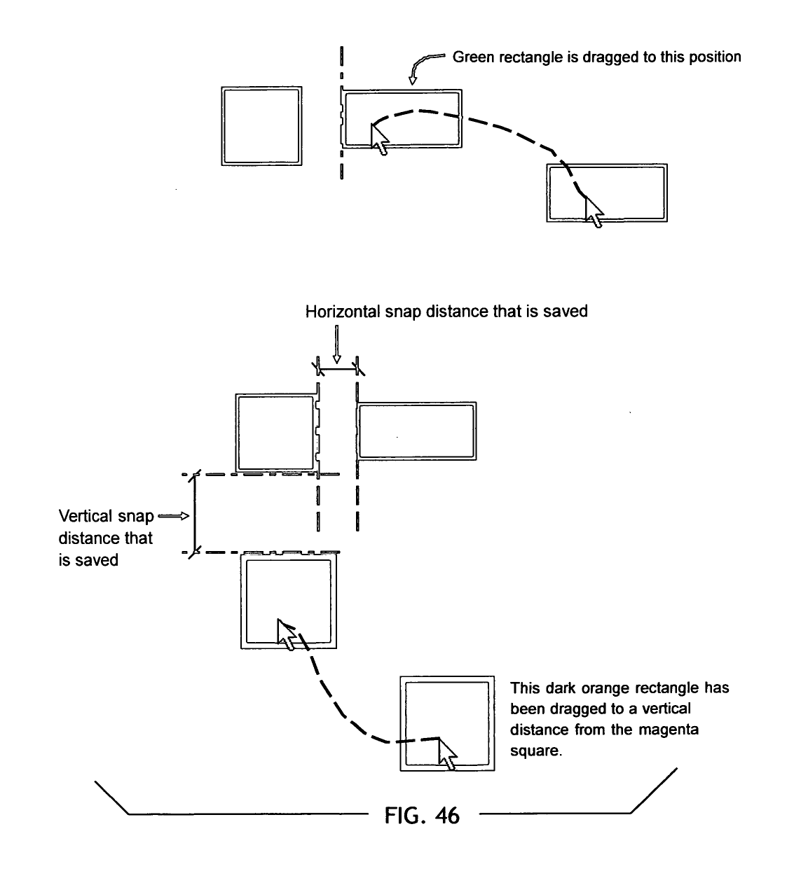

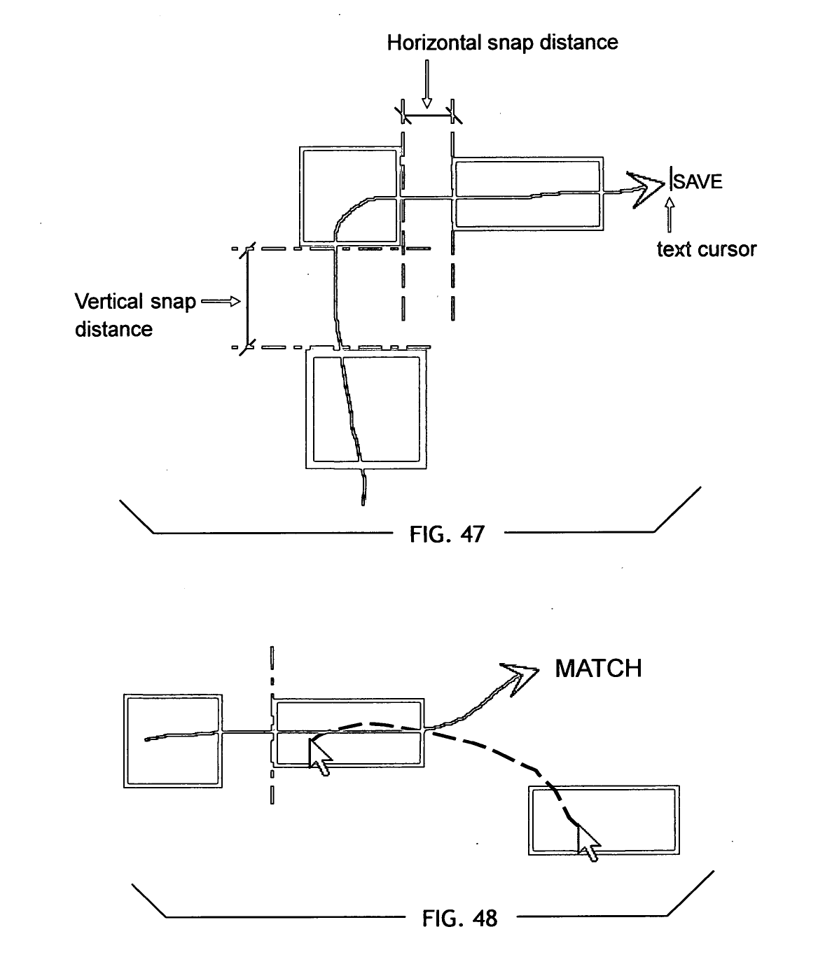

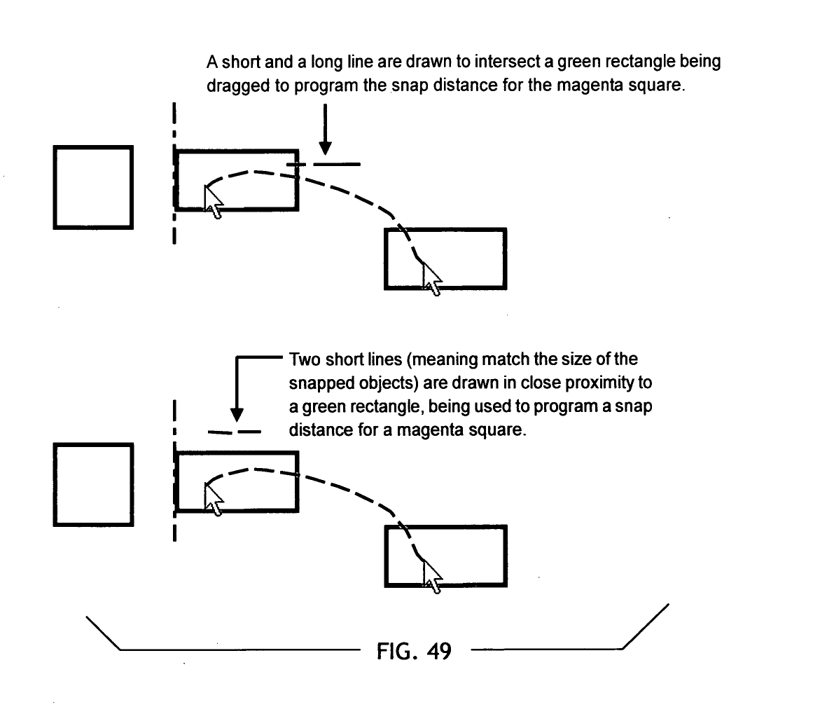

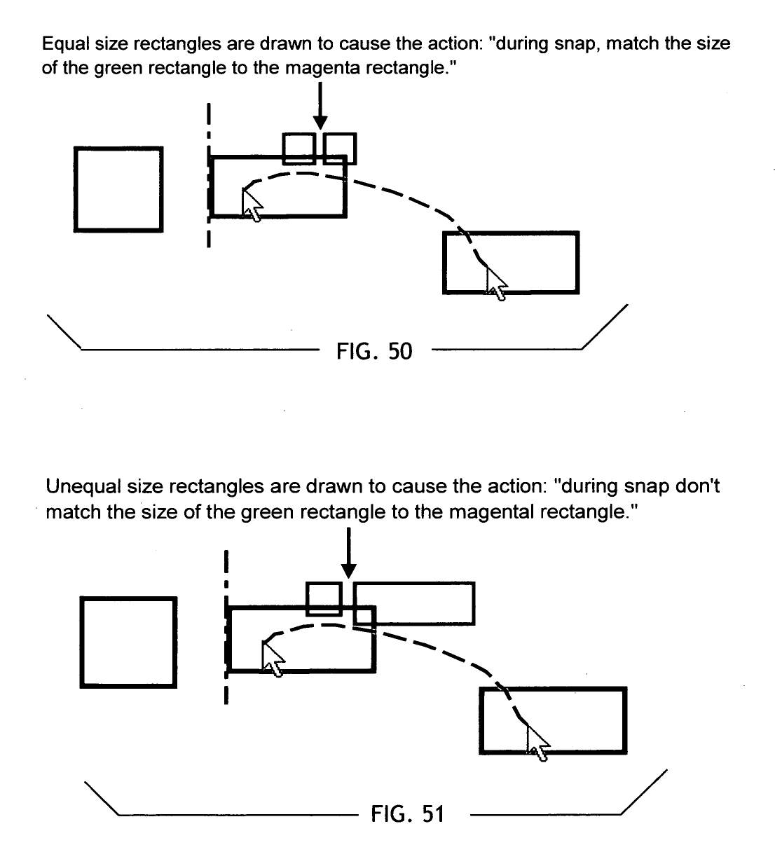

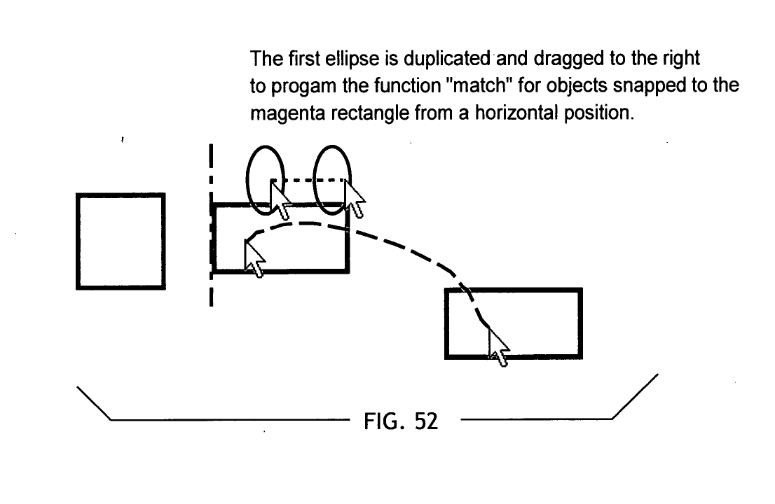

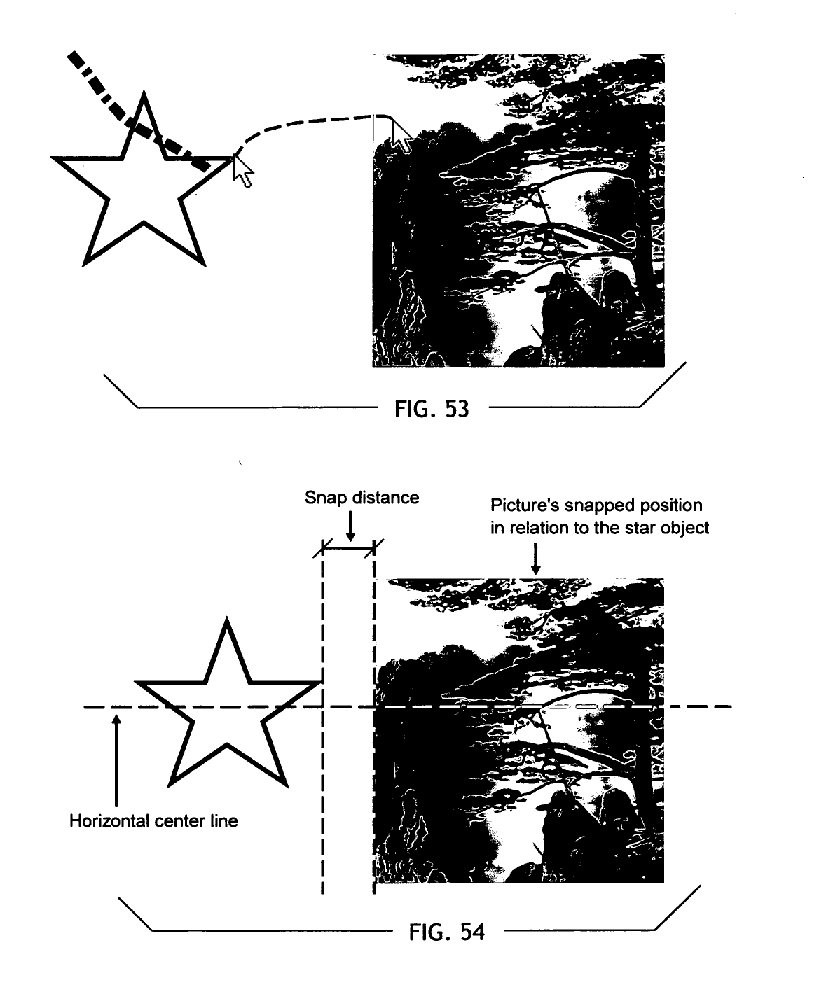

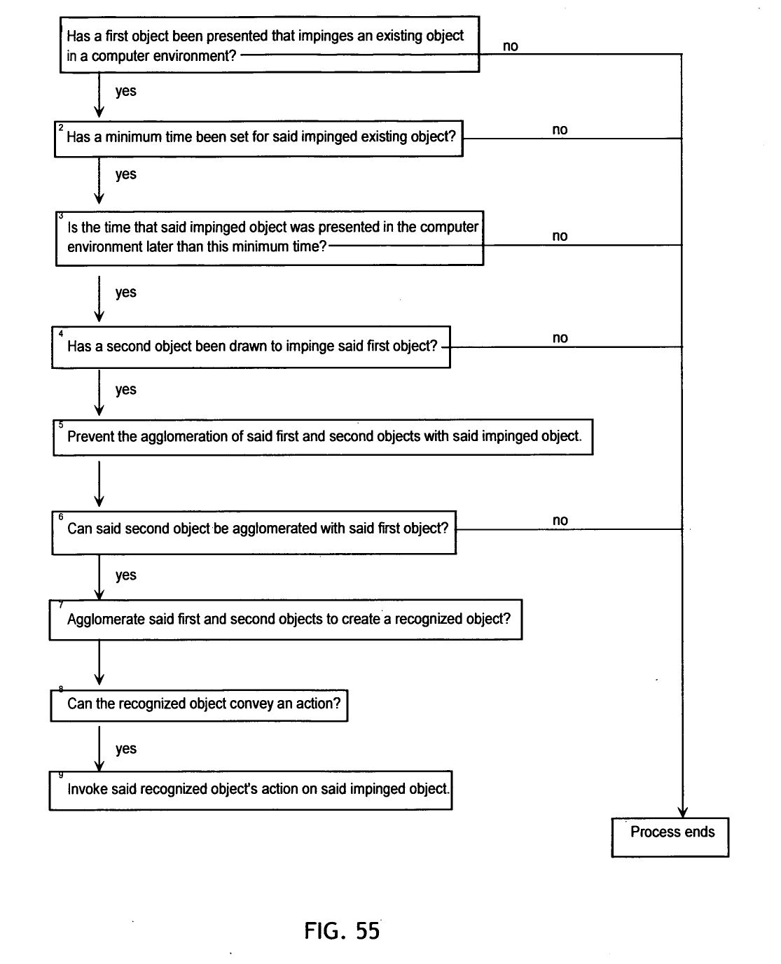

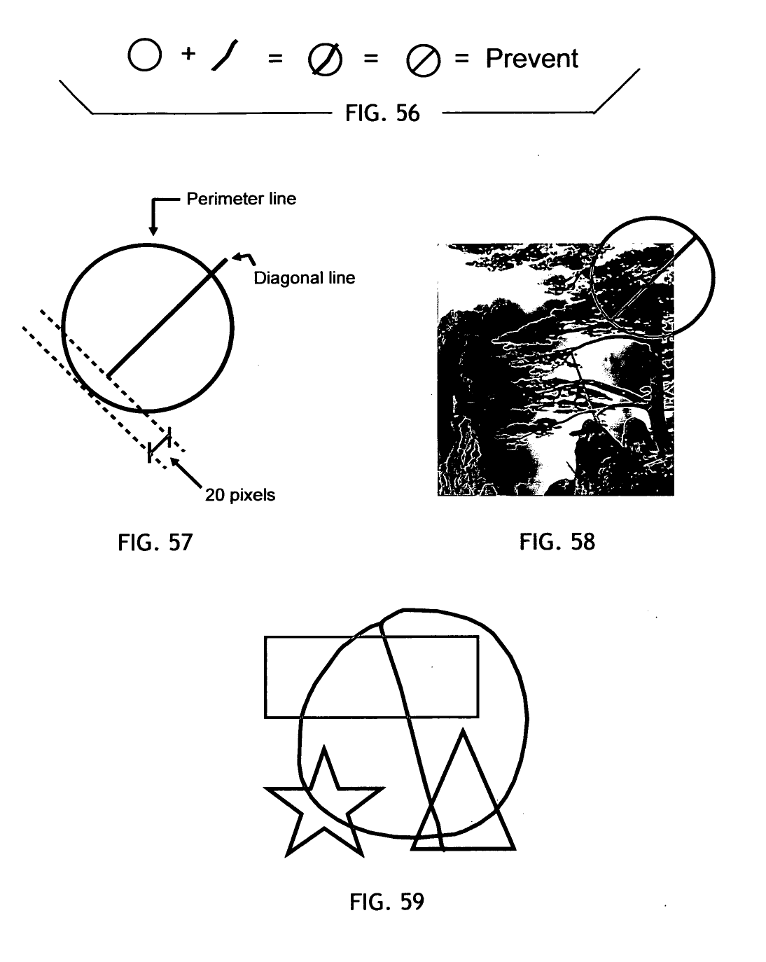

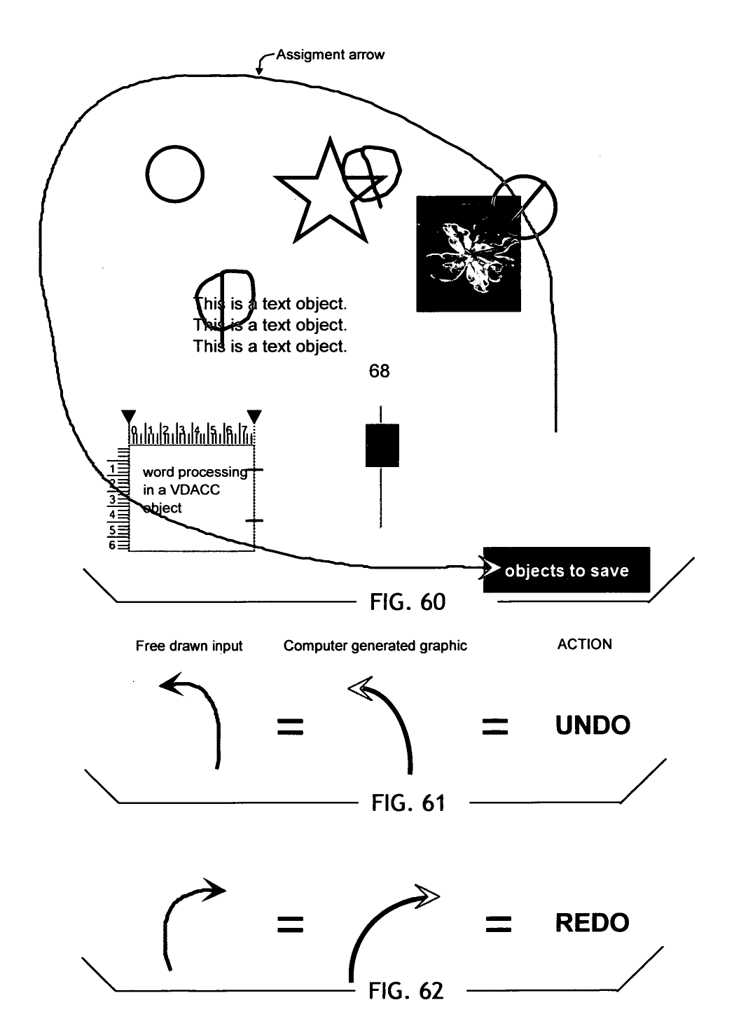

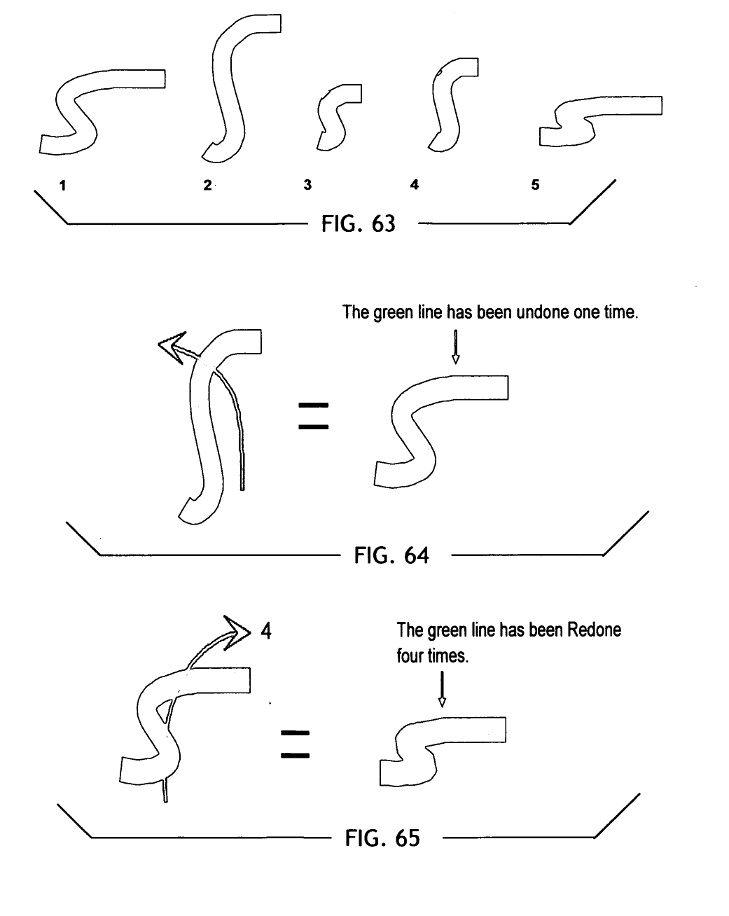

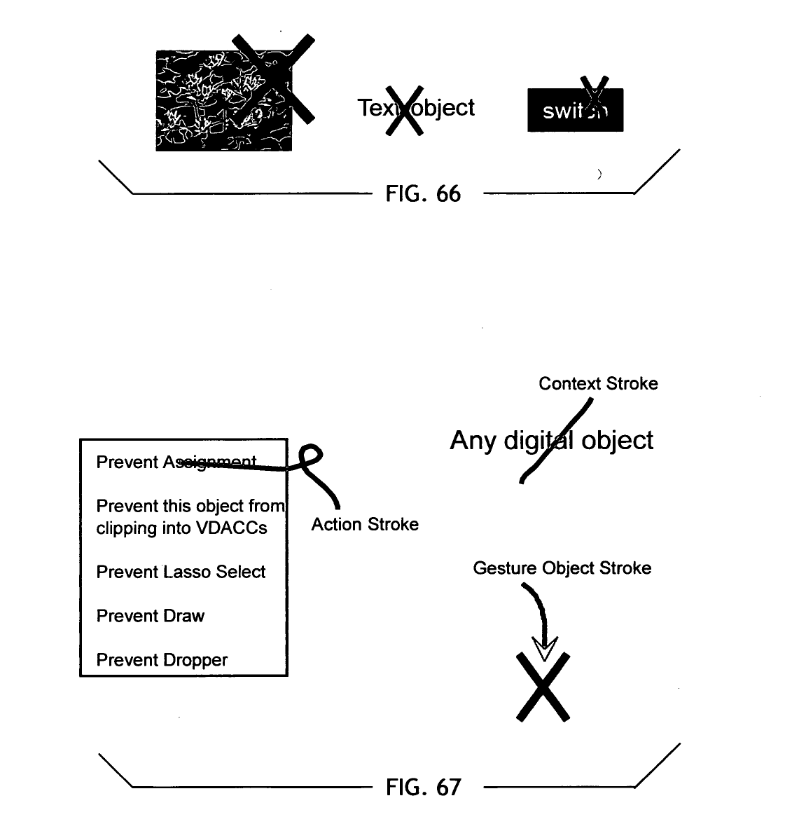

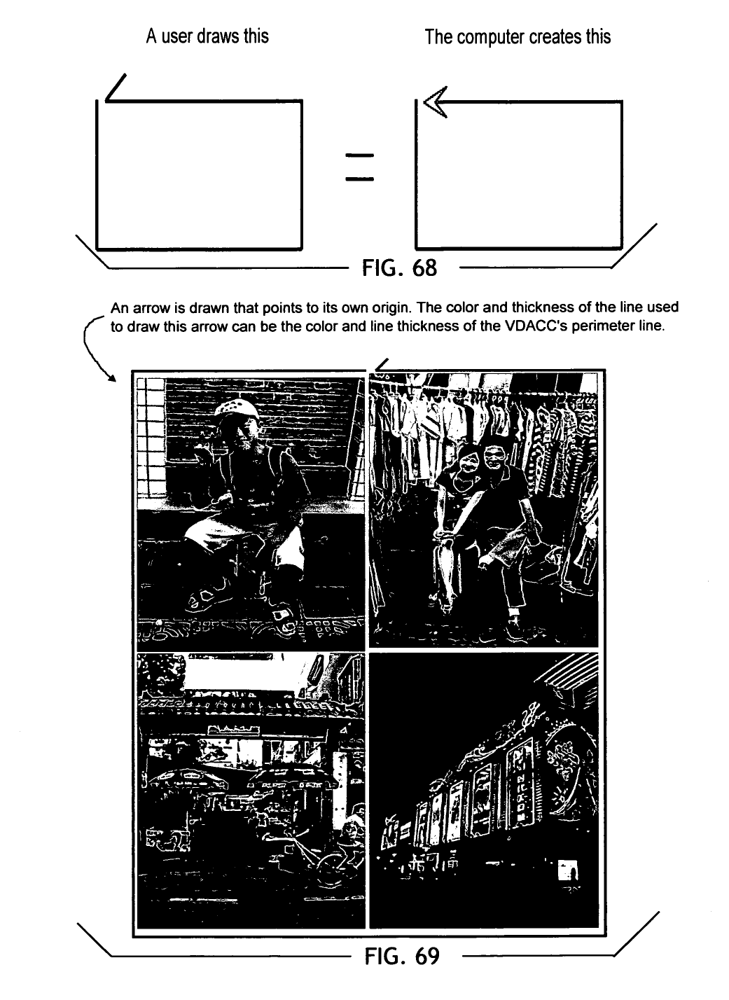

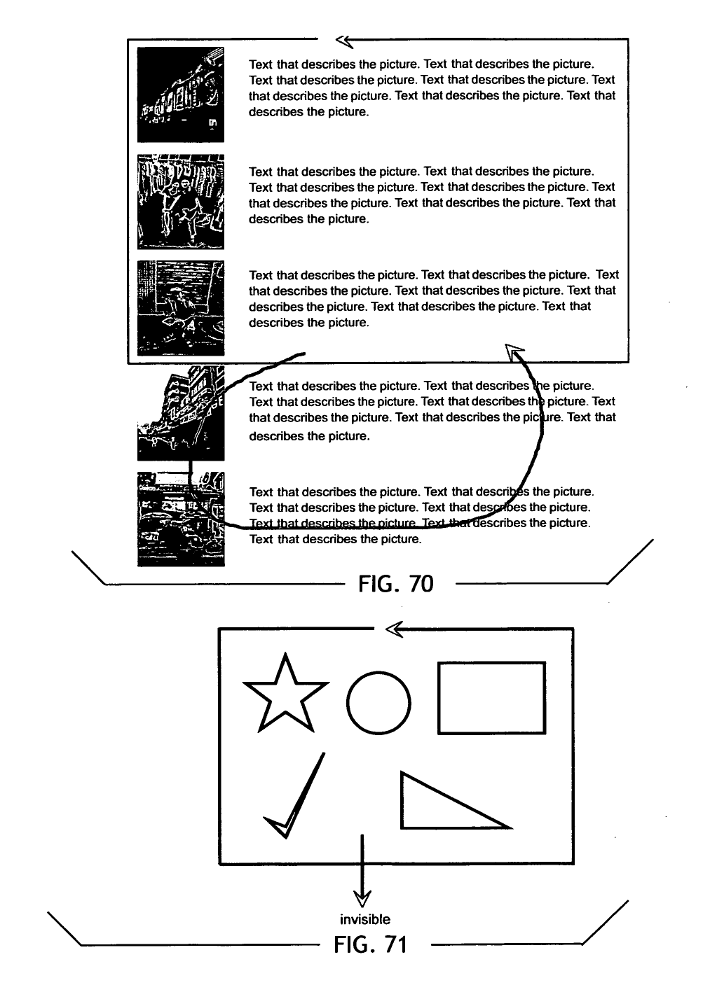

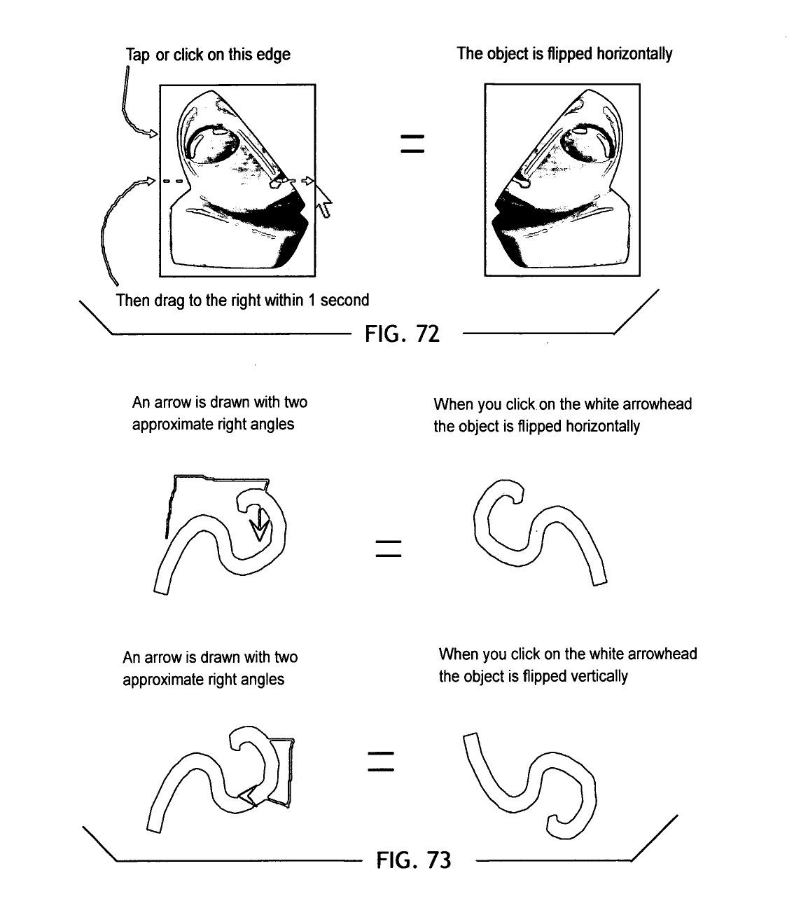

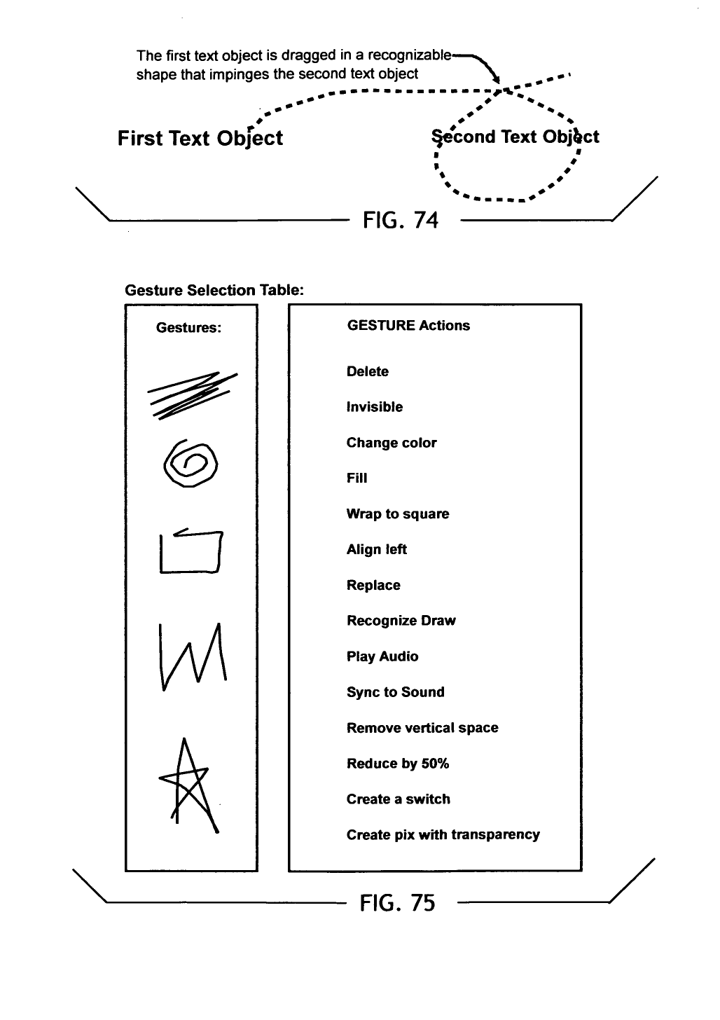

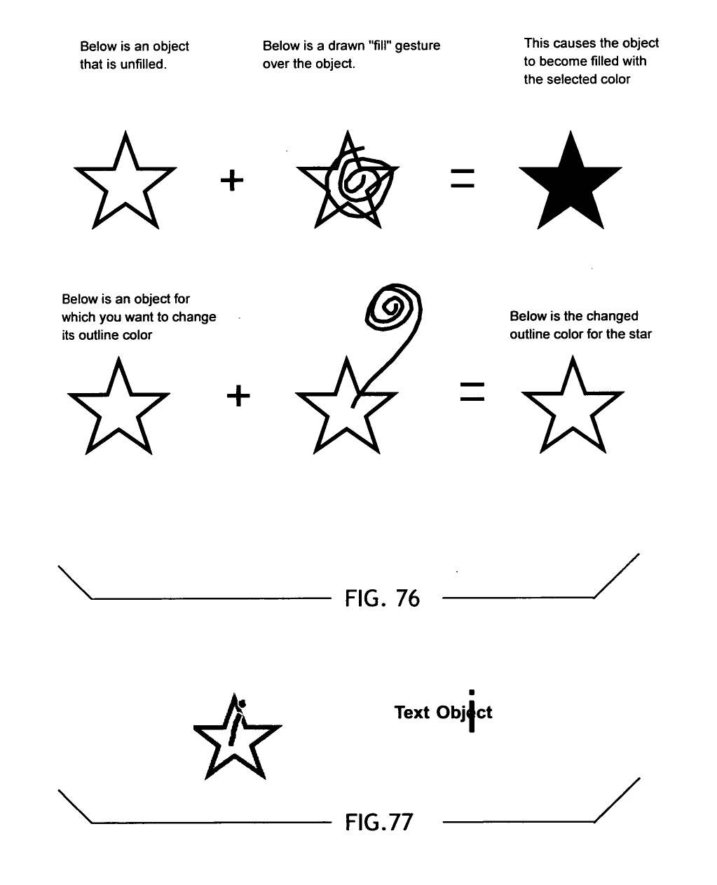

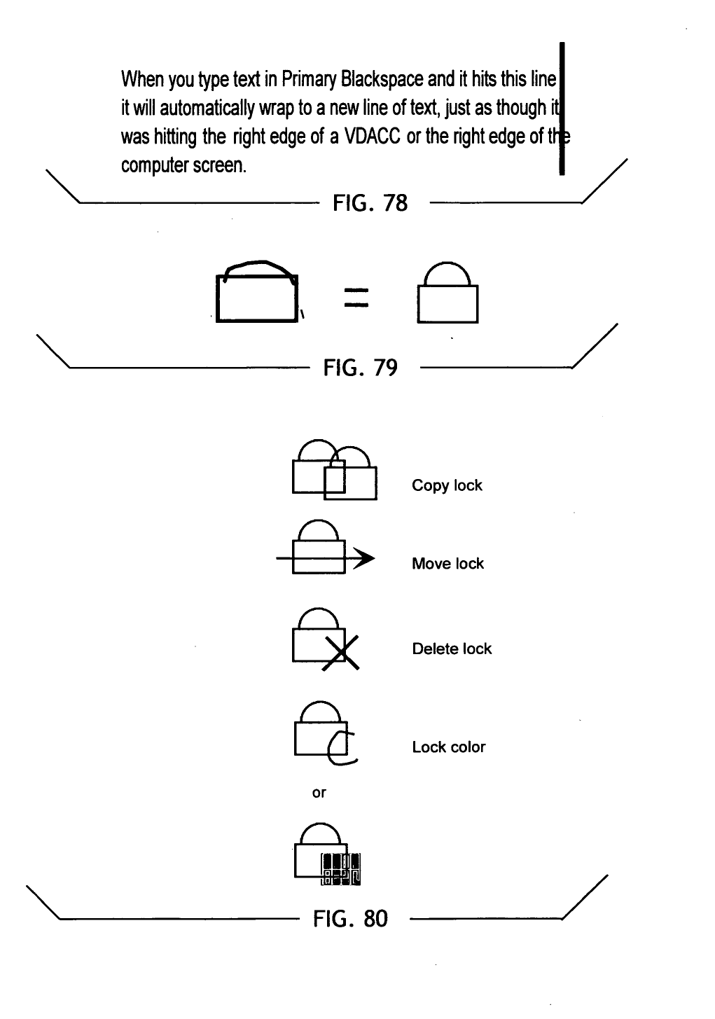

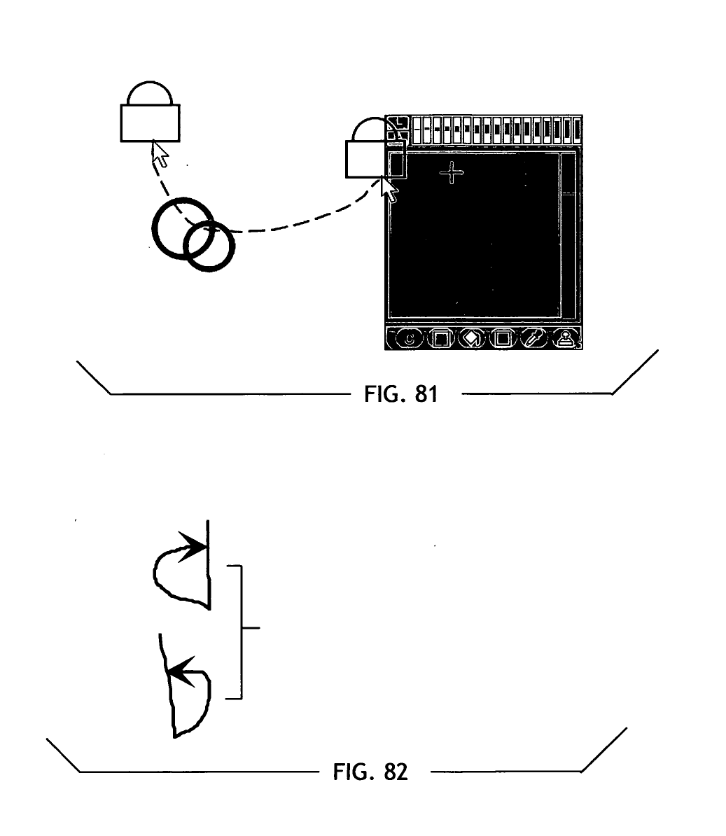

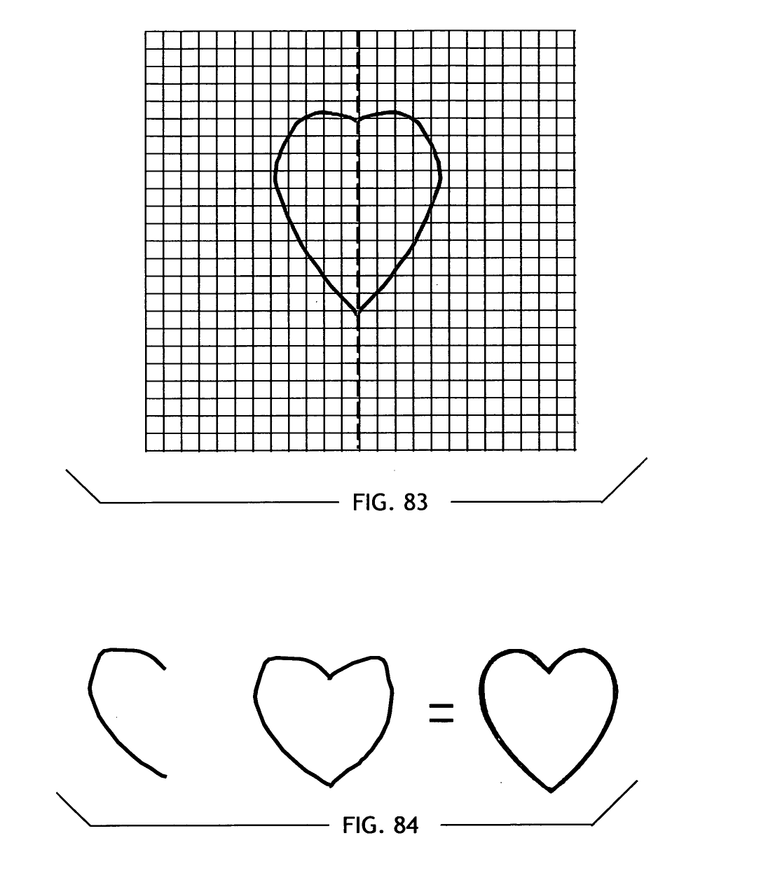

Then when the user activates a recognize draw mode and draws the new object, in this case a heart, the computer creates a perfect computer rendered heart from the user's free drawn object. And the user would only need to draw half of the object. This process is shown in FIG. 84.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A method for controlling computer operations by displaying graphic objects in a computer environment and entering user inputs to the computer environment through user interactions with graphic objects, the method comprising replacing pull-down and pop-up menu functions with graphic gestures drawn by a user as inputs to a computer system.
